(19) United States
(12) Patent Application Publication
(10) Pub. No.: US 2014/0011173 A1
(43) Pub. Date: Jan. 9, 2014

(54) TRAINING, SKILL ASSESSMENT AND MONITORING USERS IN ULTRASOUND GUIDED PROCEDURES

(71) Applicants: Ron Tepper, Herzlia (IL); Roman Shklyar, Holon (IL)

(72) Inventors: Ron Tepper, Herzlia (IL); Roman Shklyar, Holon (IL)

(73) Assignee: Mor Research Applications Ltd., Tel-Aviv (IL)

(21) Appl. No.: 14/005,556

(22) PCT Filed: Mar. 13, 2012
(86) PCT No.: PCT/IL2012/050087

§ 371 Date: Sep. 17, 2013

Related U.S. Application Data
(60) Provisional application No. 61/453,594, filed on Mar. 17, 2011.
(60) Provisional application No. 61/453,593, filed on Mar. 17, 2011.

(51) Int. Cl. G09B 23/28

(52) U.S. Cl. CPC G09B 23/281
USPC 434/273; 434/262

(57) ABSTRACT

There is provided in accordance with an exemplary embodiment of the invention a method for monitoring or training in ultrasound guided procedures. There is also provided in accordance with an exemplary embodiment of the invention a pregnant woman simulator for simulating ultrasound guided procedures.

### RELATED APPLICATION

This is a PCT application which claims the benefit of priority of U.S. Provisional Patent Applications No. 61/453,594 filed Mar. 17, 2011, and No. 61/453,593 filed Mar. 17, 2011 the contents of which are incorporated herein by reference in their entirety.

The present application is related to co-filed, co-pending and co-assigned patent application entitled “TRAINING, SKILL ASSESSMENT AND MONITORING USERS OF AN ULTRASOUND SYSTEM” (attorney docket no. 53445) by Ron TEPPER and Roman SHKLYAR, showing for example, a system, a method and software for training practitioners in use of an ultrasound system, the disclosure of which is incorporated herein by reference.

### FIELD AND BACKGROUND OF THE INVENTION

The present invention, in some embodiments thereof, relates to a system and/or method for medical training, assessment and/or monitoring and, more particularly, but not exclusively, to an ultrasound image guided invasive procedure monitor, trainer and/or creditor.

Butsev et al. in US 2006/0069536 disclose: “A method includes receiving data values associated with one of a position and orientation of a simulated scanner relative to an object. Image values are calculated, substantially in real-time, based on the data values. A simulated ultrasound image is rendered in a graphical display based on the image values.”

Aiger et al. in U.S. Pat. No. 6,210,168 disclose: “A method and system for simulating, on a B-mode ultrasound simulator, a D-mode and C-mode Doppler ultrasound examination. Velocity and sound data describing blood flow at selected locations within blood vessels of a patient are gathered during an actual Doppler ultrasound examination. The gathered data are processed off-line to generate sets of flow velocity and sound values which describe blood flow at selected locations in a virtual B-mode frame buffer, and are stored in memory. Doppler simulation at a designated location on a the B-mode image generated from the virtual frame buffer . . . ”

Hendrickson et al. in US 2005/0277096 disclose: “A portable medical simulation system and method employs an artificial patient with a built-in haptic interface device, with up to four carriages for engaging different diameter catheters . . . . A contrast display visual effect derived from a particle emitter software tool simulates the release of radiopaque dye within a simulated vasculature system for display on a monitor. A computer software based system is used for generating haptic effects on the catheter through control signals passed to each of the carriage motors controlling translation movement of the catheter and magnetic particle brakes controlling rotational movement of the catheter.”

Additional background art includes:
U.S. Pat. No. 5,609,485
U.S. Pat. No. 7,545,985
US application 2003/0198936
US application 2007/0082324
US application 2007/0172803
US application 2007/0207448
US application 2007/0271503
US application 2008/0085501
Jensen, Wood, Wood. Hands-on Activities, Interactive Multimedia and Improved Team Dynamics for Enhancing Mechanical Engineering Curricula. Int. J. Engng Ed. Vol. 19, No. 6, pp. 874-884, 2003
Kass et al. Snakes: Active Contour Models. International Journal of Computer Vision, 321-331 (1988).

### SUMMARY OF THE INVENTION

According to an aspect of some embodiments of the present invention there is provided a method and/or a system for monitoring and/or training in ultrasound guided invasive procedures. The approximate and/or putative relative positions of one or more tools, and one or more anatomical features are analyzed, to determine one or more performances. Feedback is provided about the performance. Optionally, an object is provided for simulating ultrasound guided invasive procedures on pregnant women. Alternatively or additionally, an unexpected event can be simulated, such as the movement of a target tissue (e.g., fetus) into the path of the tool.

There is provided in accordance with an exemplary embodiment of the invention a method for monitoring or training in ultrasound guided procedures comprising:

determining at least one of, relative putative positions, or features in an ultrasound image, of one or more tools, and one or more anatomical features;

analyzing the relative putative positions;

determining a score in the analysis; and

providing feedback related to the score.

In an exemplary embodiment of the invention, the method further comprises generating an unexpected event; and determining a score in the analysis according to the unexpected event.

In an exemplary embodiment of the invention, the method further comprises determining a score in the analysis according to a training script.

In an exemplary embodiment of the invention, the method further comprises providing feedback of an evaluation report according to the analysis of the training script. Optionally, feedback of training materials is provided according to the training script.

In an exemplary embodiment of the invention, the method further comprises determining putative positions relative to an ultrasound image plane or an ultrasound image volume.

In an exemplary embodiment of the invention, the anatomical feature is at least one of target tissue or tissue to avoid.

In an exemplary embodiment of the invention, analyzing the relative positions comprises analyzing the relative positions according to an image feature database.

In an exemplary embodiment of the invention, analyzing the relative positions comprises analyzing the relative positions according to a database of positions.

In an exemplary embodiment of the invention, the score is related to the relative positions.

In an exemplary embodiment of the invention, the feedback is at least instructions to reposition the image or to set image parameters. Alternatively or additionally, the feedback is instructions to proceed safely. Alternatively or additionally, the feedback is instructions to proceed with caution. Alternatively or additionally, the feedback comprises teaching how to improve the score.

In an exemplary embodiment of the invention, the method further comprises selecting at least one of a monitor mode, a training mode or an evaluation mode. Optionally, the feedback is according to the mode.

In an exemplary embodiment of the invention, at least one of the tool or the anatomical features is marked.

There is provided in accordance with an exemplary embodiment of the invention a pregnant woman simulator comprising:

a simulated uterus;

a simulated amniotic fluid within the uterus; and

one or more of a simulated fetus configured to at least one of move or change a position within the uterus and the amniotic fluid.

In an exemplary embodiment of the invention, the simulator further comprises a simulated placenta configured to change a position within the uterus. Optionally, the simulator further comprises at least one motor to change or move the simulated placenta.

In an exemplary embodiment of the invention, the simulator further comprises a simulated umbilical cord connecting the fetus to the placenta, the umbilical cord configured to move. Optionally, the simulator comprises at least one motor to change or move the simulated umbilical cord.

In an exemplary embodiment of the invention, the simulator further comprises one or more control circuitry configured to at least one of move or change the position.

In an exemplary embodiment of the invention, the fetus is inflatable to change the size of the fetus. Optionally, the simulator comprises at least one motor to change or move the fetus. Alternatively or additionally, the simulator further comprises at least one propeller to change or move the fetus. Alternatively or additionally, the simulator further comprises at least one cable to change or move the fetus. Alternatively or additionally, the simulator further comprises at least one magnet to change or move the fetus. Alternatively or additionally, a lever is configured to the at least one of move or change the position of the fetus.

In an exemplary embodiment of the invention, the simulated placenta comprises a material to simulate a biopsy.

In an exemplary embodiment of the invention, the movement of the fetus comprises selecting from the group consisting of: limb flexion, limb extension, limb adduction, limb abduction, limb internal rotation, limb external rotation, limb elevation, limb depression, fetus displacement, fetus rotation, fetal breathing.

In an exemplary embodiment of the invention, changing the position of the fetus comprises selecting from the group consisting of: left, right, anterior, posterior, breech, vertex, occiput anterior, occiput posterior.

In an exemplary embodiment of the invention, the position of the simulated placenta comprises selecting from the group consisting of: placenta anterior, placenta posterior, placenta previa.

In an exemplary embodiment of the invention, the amniotic fluid is removable by the tool.

In an exemplary embodiment of the invention, the simulator further comprises a maternal bladder configured to hold a variable amount of simulated urine.

In an exemplary embodiment of the invention, the simulator further comprises maternal lungs operable to push at least one of uterus or fetus during simulated breathing.

In an exemplary embodiment of the invention, the simulator further comprises maternal intestines operable to simulate peristalsis.

There is provided in accordance with an exemplary embodiment of the invention a system for monitoring or training in ultrasound guided procedures comprising:

a unit for generating at least one of an ultrasound image or position data;

circuitry for determining one or more positions of one or more tools and one or more anatomical features according to the image or the data;

circuitry for determining one or more scores of the positions; and

a feedback unit operable to output the score.

In an exemplary embodiment of the invention, the unit is an ultrasound machine.

In an exemplary embodiment of the invention, the system further comprises a transducer; and a sensor configured to determine a position data of the transducer.

In an exemplary embodiment of the invention, the system further comprises a tool; and a sensor configured to determine a position data of the tool.

In an exemplary embodiment of the invention, the system further comprises one or more elements to enhance visibility of the tool on the ultrasound image.

In an exemplary embodiment of the invention, the system further comprises one or more wireless receivers configured to transmit at least one of the position data of the tool or the position data of the transducer to the circuitry for determining one or more positions.

In an exemplary embodiment of the invention, the system further comprises a user interface for programming the one or more scores. Optionally, the user interface is used for setting one or more parameters of the image.

In an exemplary embodiment of the invention, generating the ultrasound image comprises retrieving the image from an ultrasound image database according to the position data.

In an exemplary embodiment of the invention, the system further comprises a pregnant woman simulator comprising a simulated fetus, and wherein the ultrasound image is an ultrasound image of the pregnant woman simulator. Optionally, the simulator comprises a sensor on the fetus, the sensor configured to determine a position data of the fetus.

There is provided in accordance with an exemplary embodiment of the invention a device for simulating the resistance of a tool used to perform an invasive procedure comprising:

a traction control element to provide varying levels of resistance to a tool;

a motor configured to set traction control element to varying levels of resistance;

an insertion sensor to detect the insertion of the tool;

a flexible member operable to provide angular insertion of the tool;

a position sensor to detect the position of the tool; and

a processor configured to at least one of transmit position data or receive resistance instruction.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1A is a block diagram of the ultrasound training system, in accordance with an exemplary embodiment of the invention;

FIG. 1B is a block diagram of some alternative embodiments of the ultrasound training system, in accordance with an exemplary embodiment of the invention;

FIG. 2A is an example of the image feature database, in accordance with an exemplary embodiment of the invention;

FIG. 2B is an example of a position database with reference to target tissue, in accordance with an exemplary embodiment of the invention;

FIG. 2C is an example of a position database with reference to tissues to avoid, in accordance with an exemplary embodiment of the invention;

FIG. 3A is an illustration of a pregnant woman simulator, in accordance with an exemplary embodiment of the invention;

FIG. 3B is a close up illustration of electromechanical systems enabling movement of some tissues of the pregnant woman simulator of FIG. 3A, in accordance with some embodiments of the invention;

FIG. 4 is an illustration of a tool resistance simulation device of FIG. 3A, in accordance with some embodiments of the invention;

FIG. 5 is an example of a training script, in accordance with an exemplary embodiment of the invention;

FIG. 6 is a flowchart of an image formation software, in accordance with some embodiments of the invention;

FIG. 7 is an example of a training evaluation report, in accordance with an exemplary embodiment of the invention;

FIG. 8 is a flowchart of modes of operation, in accordance with some embodiments of the invention;

FIG. 9A is an illustration of a screen capture of the feedback unit, in accordance with an exemplary embodiment of the invention; and

FIG. 9B is an illustration of another screen capture of the feedback unit, in accordance with an exemplary embodiment of the invention.

### DESCRIPTION OF SPECIFIC EMBODIMENTS OF THE INVENTION

The present invention, in some embodiments thereof, relates to a system and/or method for medical training, assessment and/or monitoring and, more particularly, but not exclusively, to an ultrasound image guided invasive procedure monitor, trainer and/or creditor.

An aspect of some embodiments of the invention relates to a method for monitoring and/or training in ultrasound guided procedures. The relative and/or absolute putative positions of one or more tools relative to one or more anatomical features are determined. The positions are analyzed to determine one or more performances. Optionally, a score is calculated, estimated and/or determined. Alternatively or additionally, hand movements during the procedure are analyzed.

In an exemplary embodiment of the invention, the tool is a needle.

In an exemplary embodiment of the invention, the anatomical feature is target tissue to contact with the tool. Alternatively or additionally, the anatomical feature is tissue to avoid contacting with the tool.

In an exemplary embodiment of the invention, the relative positions are estimated from an ultrasound image (e.g., real and/or simulated). Optionally, alternatively or additionally, positions are estimated from another image, for example, generated by CT, MRI, x-ray. Alternatively or additionally, the relative positions are calculated and/or estimated from the positions of the tool and/or a transducer, for example, using sensors that provide position data. Alternatively or additionally, the relative positions are calculated and/or estimated from the positions of the anatomical features, for example, using a simulated object with preset positions and/or using a sensor to detect the positions of the object and/or anatomical features.

In an exemplary embodiment of the invention, the ultrasound image is provided by a functional ultrasound machine, for example, of a living patient and/or imaging phantom. Alternatively or additionally, the ultrasound image is simulated (e.g., using a database of ultrasound images, using a database of images from other imaging modalities such as CT, MRI, x-ray that have been rendered to simulate ultrasound images), for example, when using a mannequin.

In an exemplary embodiment of the invention, the ultrasound image is analyzed using a feature database. Optionally, the ultrasound image comprising one or more of, the end of the tool (e.g., needle tip), target tissue and/or tissue to avoid, is analyzed. Alternatively or additionally, a score is estimated and/or calculated. Alternatively or additionally, a comment is determined.

In an exemplary embodiment of the invention, if the tip of the needle is not visible on the ultrasound image, a warning and/or failing score is provided and/or estimated. Alternatively or additionally, if the tip of the needle is visible on the image, but repositioning and/or adjusting the ultrasound image is required, a passing score and/or comment is estimated and/or provided. Alternatively or additionally, if the image comprises the required tool and/or anatomical features, an honors passing score and/or comment is estimated and/or provided. In an exemplary embodiment of the invention, an overall score is determined according to the score over a number of images, for example, the overall score is pass if the score is pass for at least 50% of images.

In an exemplary embodiment of the invention, a distance and/or position is estimated and/or calculated between a part of the tool such as the tip and any target tissue. Alternatively or additionally, a distance and/or position is estimated and/or calculated between the tool and tissue to avoid. Optionally, the distance includes contacting the tissue and/or piercing through the tissue, for example, zero distance and/or negative distance.

In an exemplary embodiment of the invention, the position is analyzed using a position database. Optionally, a score is estimated and/or determined. Additionally or alternatively, a comment is determined. In some embodiments, the score and/or comment are provided as feedback.

In an exemplary embodiment of the invention, the score is related to a relative distance between the tool, (e.g., end of the tool) such as along the path of the tool, and/or one or more of the anatomical features. Optionally or alternatively, the score is related to the risk and/or ease of repositioning the tool and/or transducer (e.g., to form a new image).

In an exemplary embodiment of the invention, the score is related to the tip of the tool relative to the target feature. Optionally, a failing score indicates piercing through the target (e.g., to the other side), and/or the tool not being lined up with the target (e.g., tool requires repositioning). Alternatively or additionally, a passing score indicates that the tool will eventually reach the target with forward movement of the tool. Alternatively or additionally, an honors passing score indicates that the tool is in the correct position, for example, inside the target.

In an exemplary embodiment of the invention, the score is related to the tip of the tool relative to the feature to avoid. Optionally, a failing score indicates contact between the tool and/or the feature to avoid. Alternatively or additionally, a pass indicates the tool is relatively close to the feature to avoid, for example, relatively small movements forward will result in contact. Alternatively or additionally, an honors pass indicates that the tool is relatively far from the feature to avoid, and relatively large movements forward and/or repositioning of the tool will be result in contact.

In an exemplary embodiment of the invention, feedback is provided about the tool, target tissue and/or tissues to avoid, for example on the ultrasound image.

In an exemplary embodiment of the invention, feedback is provided according to distance and/or path of the tool.

In an exemplary embodiment of the invention, feedback comprises advice, a warning and/or an error. Optionally, advice comprises instructions on how to proceed.

In an exemplary embodiment of the invention, an unexpected event is generated.

In an exemplary embodiment of the invention, a training script is provided to direct training.

In an exemplary embodiment of the invention, performance is evaluated, for example, by returning a grade and/or a score.

In an exemplary embodiment of the invention, a training report is provided. Optionally, the report comprises an evaluation of the performance of the user, for example, relative to previous performance and/or relative to performance of other users. Alternatively or additionally, the evaluation is relative to the training script. Alternatively or additionally, the evaluation is relative to a hazard map zone, for example, the amount of time the tool was in the right location, the amount of time the tool was dangerously close to tissues, the number of errors performed (e.g., tool piercing wrong tissue).

In an exemplary embodiment of the invention, a training mode, an evaluation mode and/or a monitor mode is selected. Optionally, in training mode, the procedure is taught, for example, using a training script. Alternatively or additionally, in evaluation mode, the score is provided about the performance. Alternatively or additionally, in monitor mode, assistance in performing the procedure is provided, for example, by feedback.

An aspect of some embodiments of the invention relates to a system for monitoring and/or training in ultrasound guided invasive procedures. The ultrasound training system comprises a unit for generating one or more ultrasound images, circuitry for analyzing the images and/or determining the performance, and a feedback unit for outputting the images and/or the performance.

In some embodiments of the invention, the ultrasound system further comprises one or more tools for performing a procedure. Additionally or alternatively, the system further comprises a transducer (e.g., functional or mock) for generating an ultrasound image. Additionally or alternatively, the system further comprises one or more sensors coupled to the tool and/or transducer, configured to provide the position of the tool and/or transducer. Additionally or alternatively, the system further comprises a feedback unit for outputting the ultrasound image, the performance and/or information associated with the performance.

In an exemplary embodiment of the invention, the ultrasound training system further comprises an object for simulating an ultrasound guided invasive procedure. Optionally, the object is an imaging phantom. Alternatively or additionally the object is a mannequin. Alternatively, the object is a living patient.

An aspect of some embodiments of the invention relates to a simulated portion of a pregnant woman for simulating an ultrasound guided procedure, for example, one or more of amniocentesis, chorionic villus sampling, biopsy. The pregnant woman simulation is a mannequin (e.g., using a dataset of ultrasound images), an imaging phantom and/or a combination of both. In an exemplary embodiment of the invention, the simulator comprises and/or simulates one or more of, maternal breathing (e.g., moves fetus), moving maternal intestines (e.g., peristalsis), maternal bladder (e.g., empty and/or with urine) a fetus operable to simulate fetal movements, a placenta operable to simulate placental positions, fluid to simulate amniotic fluid, umbilical cord operable to move, a needle resistance device to simulate resistance during the insertion of the tool. Optionally, one or more simulated tissues are transparent and/or translucent. A potential advantage of transparent or translucent simulated tissues is to visually correlate the position of the needle inside the simulator with the ultrasound image.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

### Exemplary Embodiment

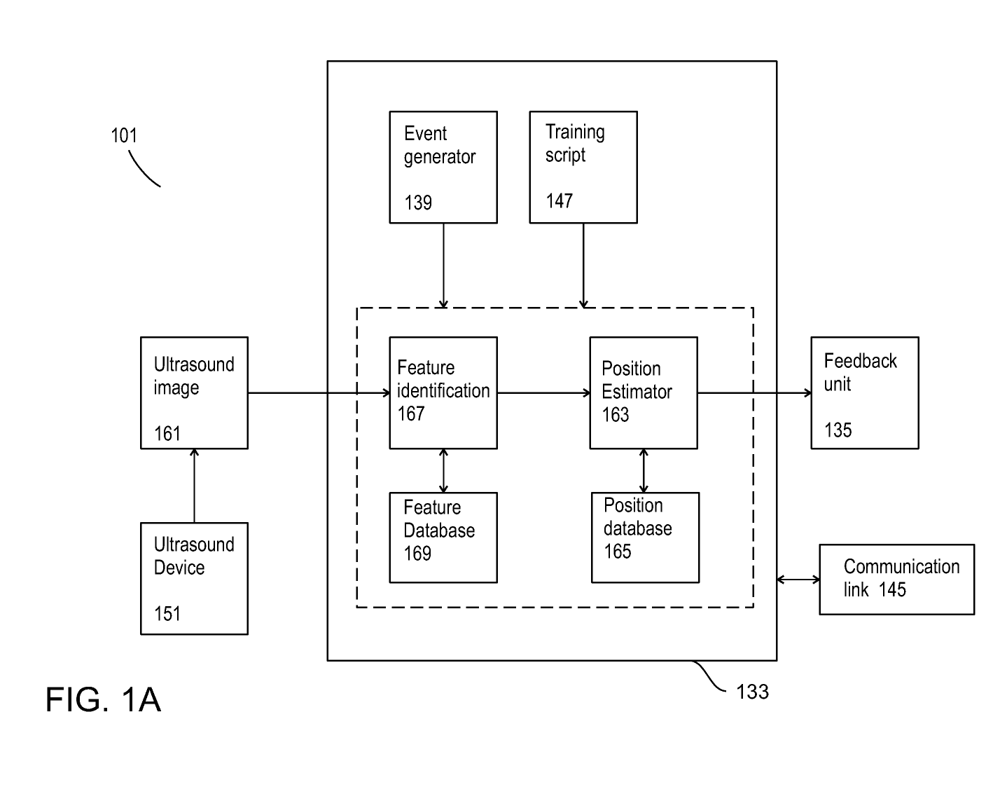

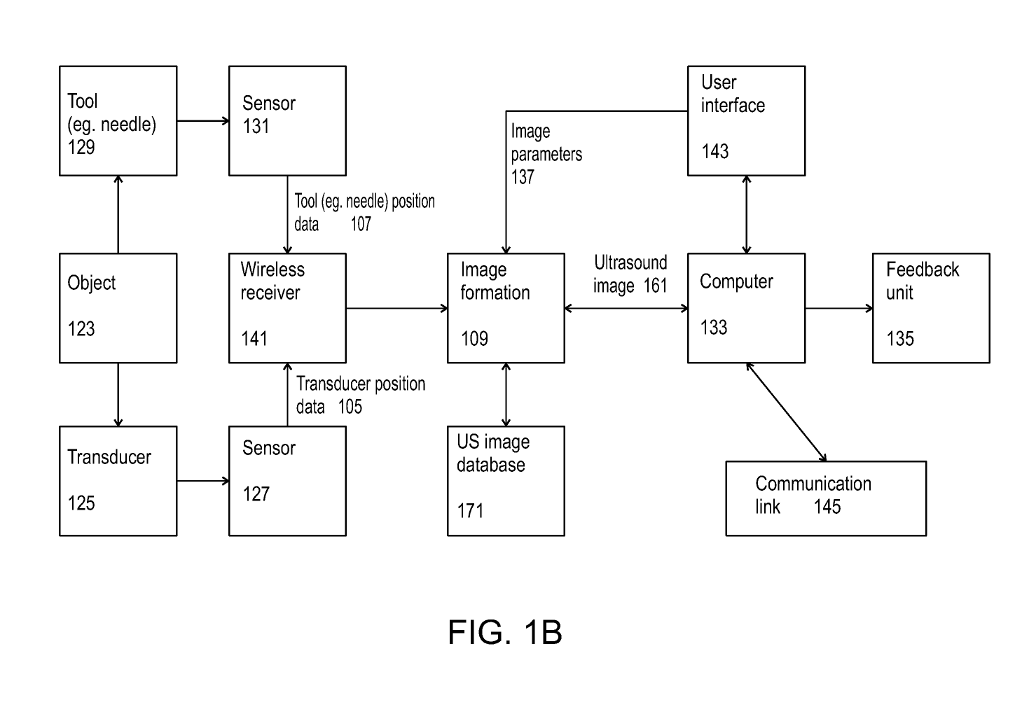

Referring now to the drawings, FIG. 1A is a block diagram of an ultrasound training system 101, in accordance with an exemplary embodiment of the invention. In an exemplary embodiment of the invention, the approximate and/or putative relative locations of a tool and/or important anatomical features related to an ultrasound image 161 are analyzed. Alternatively or additionally, features that are missing and/or not visible are analyzed, for example, the tool has been inserted a distance and is not seen on image 161. Alternatively or additionally, a distance between the tool and one or more anatomical features is calculated and/or estimated. Alternatively or additionally, a score associated with the relative locations and/or the distances is provided. Alternatively or additionally, feedback associated with the relative locations and/or the distances is provided.

In an exemplary embodiment of the invention, ultrasound training system 101 monitors a user performing an ultrasound guided invasive simulated procedure on an object (e.g., mannequin and/or imaging phantom), for example, by calculating and/or estimating scores (e.g., in real time) about the changing distances and/or the changing relative positions. Alternatively, the user performs a real invasive procedure on a living patient. Alternatively, the user performs an invasive procedure on a cadaver.

The user using ultrasound training system 101, is for example, one or more individuals interested in learning to perform ultrasound guided invasive procedures, such as, medical students, residents, and/or physicians. Alternatively or additionally, the user is for example, one or more individuals who have not performed one or more procedures during a set time period and need to refresh their skills, such as attending physicians. Alternatively or additionally, the user is for example, one or more individuals being evaluated, such as under an exam setting, in order to obtain a license to perform procedures, for example, residents in an OSCE (objective structured clinical examination).

In an exemplary embodiment of the invention, an ultrasound device 151 generates ultrasound image 161 (e.g., real and/or simulated) as input to ultrasound training system 101. Optionally, device 151 is a functional ultrasound machine (e.g., standard ultrasound machine 151, for example, Voluson 730 available from General Electric. Alternatively or additionally, device 151 is an ultrasound simulator producing image, 161 that is simulated, for example, as will be described with reference to FIG. 1B.

In an exemplary embodiment of the invention, ultrasound image 161 represents, for example, one or more of, a living patient, a cadaver, an imaging phantom.

In an exemplary embodiment of the invention, ultrasound image 161 is 2 (two) dimensional. Alternatively, ultrasound image 161 is 3 (three) dimensional and/or 4 (four) dimensional. Optionally, image 161 is black and white. Alternatively or additionally, image 161 is color (e.g., Doppler).

In an exemplary embodiment of the invention, one or more ultrasound images 161 are processed at the rate of 1 per second, 10 per second, 20 per second, or other smaller intermediate or larger rates.

In an exemplary embodiment of the invention, ultrasound image 161 comprises one or more features that intersect a scanning plane, for example, one or more tools, tissues, and/or fetuses. The scanning plane refers to, for example, a two dimensional slice through the object and/or patient.

In some embodiments of the invention, ultrasound image 161 is a 3D and/or 4D image, comprising one or more features that intersect a scanning volume.

### Feature Identification

In an exemplary embodiment of the invention, a feature identification module 167 detects and/or marks one or more tools used to perform the invasive procedure on image 161, for example, a needle, a feeding tube, a drainage tube, a guidewire, a catheter, a central line, a treatment probe (e.g., radiofrequency, ultrasound). One or more examples of the needle include, a fine needle to perform aspirations, a large bore diameter needle to perform core biopsies, a needle to guide the insertion of a guidewire. Alternatively or additionally, module 167 identifies and/or marks a portion of the tool in image 161, such as the tip of the needle.

In an exemplary embodiment of the invention, module 167 identifies the tool and/or tissues on image 161 using position data for the tool and/or the transducer (e.g., using sensors), for example, if simulating ultrasound images using a database of ultrasound images. Alternatively or additionally, position data for the tool and/or the transducer and/or the object (e.g., simulated patient) are used for example, if performing the procedure on an imaging phantom object. Further details about position data is provided with reference to FIG. 1B.

In some embodiments of the invention, module 167 identifies the tool on image 161 by recognizing the shape of the tool on the image, for example, if tool is substantially straight relative to other features on the image. Alternatively or additionally, module 167 identifies the tool on image 161 by a marker, for example, a marker that is relatively reflective of US energy, such as a metal button.

In some embodiments of the invention, module 167 identifies the tool on image 161, for example, by analyzing Doppler shifts associated with a vibrating tool. Methods and/or elements to vibrate the needle are discussed with reference to FIG. 1B.

In some embodiments of the invention, module 167 identifies on image 161 one or more tissues, for example, according to acoustic impedance properties of the tissues.

In some embodiments, module 167 analyzed and/or processes (e.g., calculations) image 161 for example, for shapes and/or patterns resembling, one or more anatomical features, the tool and/or the portion of the tool, for example, by a feature finding method, such as an active contours model, such as the Snake model as described by Kass et al., contents of which are incorporated herein by reference in their entirety.

In an exemplary embodiment of the invention, module 167 identifies on image 161, one or more target tissues, (e.g., anatomical features to contact with tool in order to perform the procedure) for example, amniotic fluid, chorionic villi.

In an exemplary embodiment of the invention, module 167 identifies on image 161, one or more anatomical features to avoid contacting with the tip of the needle, for example, fetus, blood vessels, intestines, bladder, umbilical cord, lungs.

In an exemplary embodiment of the invention, module 167 marks the tools and/or anatomical features on image 161, for example, with one or more of, coloring, shading, outlining, highlighting, lines, arrows. Optionally, marking of the type and/or specific tool and/or anatomical feature is selective, for example, by the user (e.g., using an interface), by an observer (e.g., using a different interface), precalibrated (e.g., stored on a memory), by a remote observer (e.g., using a remote login). Alternatively or additionally, selective marking provides for selecting the type and/or color of marking.

In some embodiments of the invention, module 167 identifies one or more anatomical features on image 161 (e.g., from a functional US machine), by comparing against a corresponding image, such as an image from an image database of normal anatomy. The comparison can be performed, for example, by correlating the position of the scanning plane of image 161 to the image database. Once the corresponding image has been found, the anatomical features can be identified on image 161 according to the corresponding location of the anatomical features on the image from the image database. A potential advantage of using corresponding images is to identify anatomical features during a procedure of a living patient in a case where the quality of ultrasound image 161 is too poor to be directly analyzed and/or processed.

In some embodiments of the invention, the tool and/or anatomical features are manually identified and/or marked on image 161, for example, by one or more of, the user, a instructor located nearby, a remote observer (e.g., using an internet connection). For example, one image 161 can be selected in the middle of a procedure, and using the mouse (e.g., locally and/or an internet connection) and/or by touching the screen, identifying and/or marking the tool and/or anatomical features. A potential advantage of manual identification and/or marking is to correct automatic identification. Another potential advantage is to provide assistance to a user performing a procedure, for example, an attending physician sitting at home and watching the procedure on an internet connection can mark the tip of the needle and/or baby, thereby assisting the resident.

In an exemplary embodiment of the invention, module 167 maintains (e.g., continuously identifies and/or marks) the location of the tool and/or anatomical features on successive images 161 (e.g., as obtained in real time using a functional US machine), for example, by an active contours model, such as the Snake model. Alternatively, maintaining is accomplished by re-identifying the tools and/or anatomical features on each subsequent image 161.

### Feature Database

In an exemplary embodiment of the invention, an image feature database 169 determines the performance of the user (e.g., as a score) according to one or more features of image 161 (e.g., needle tip, feature to avoid and/or target feature) identified by module 167. Alternatively or additionally, the performance and/or score is provided as feedback to the user, for example, as a comment appearing on a feedback unit 135.

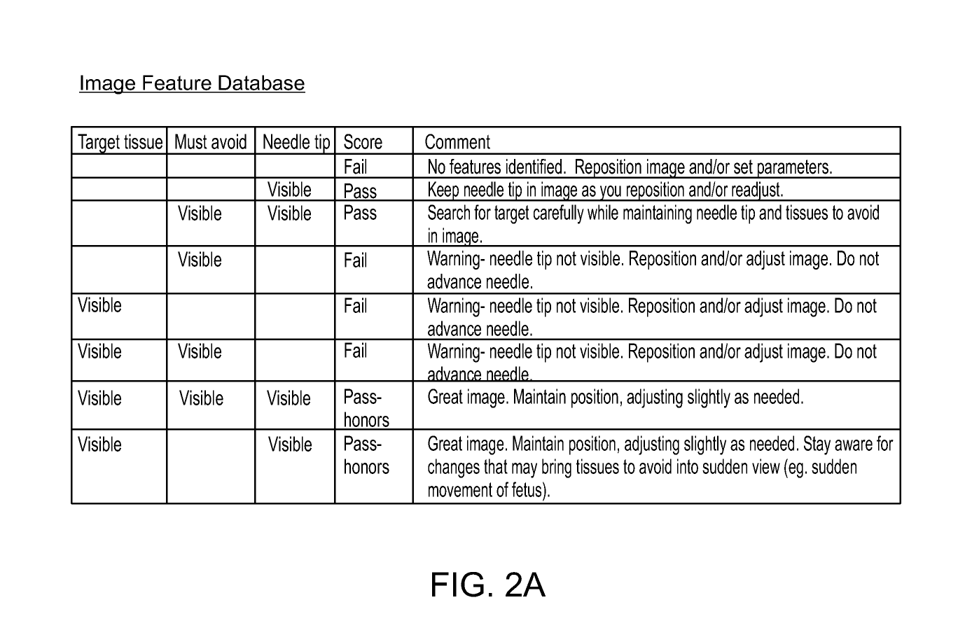

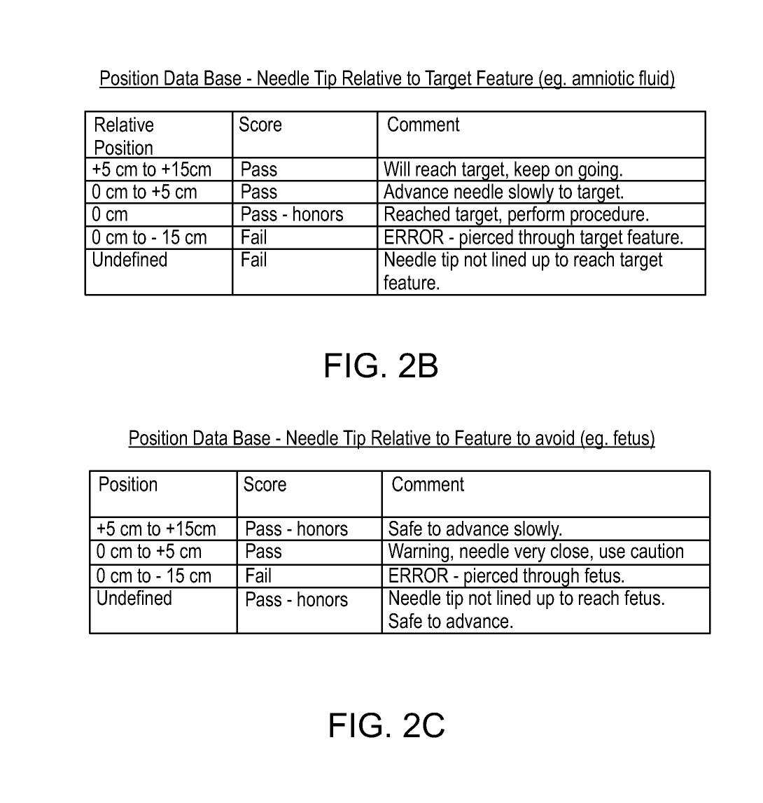

FIG. 2A is an example of image feature database 169, in accordance with an exemplary embodiment of the invention.

In an exemplary embodiment of the invention, the user is expected to perform the procedure using ultrasound imaging according to one or more of the following guidelines:

Maintain a tip of a needle in image 161 at all times.

Maintain the tip of the needle and target features in image 161 when guiding the needle.

Guide the tip of the needle towards target features.

Maintain the tip of the needle and features to avoid in image 161 when guiding the needle.

Avoid contacting features to avoid with the needle.

Examples of One or More Possible Entries Include

If the needle tip is not visible, adjusting the image by repositioning the transducer, and/or resetting the image parameters (e.g., frequency, gain, transducer shape) to bring the tip into view. A fail score is associated with lack of visibility of the needle tip, for example, due to risk of errors, such as piercing the fetus.

If the needle tip is visible, but target features are not, carefully readjusting the image to bring the target features into view. A pass score is associated with a visible needle, as errors are potentially reduced.

If the needle tip is visible, along with the target features, carefully guiding the needle to the target features, to prevent contacting features to avoid with the needle. An honors pass is associated with the visibility of the needle and anatomical features, as potentially errors are preventable.

In an exemplary embodiment of the invention, an overall score related to the score for one or more images 161 is provided, for example, the overall score is pass if the score on at least 30%, 50%, 70% or other smaller, intermediate or larger percentages of images 161 is pass.

A potential advantage of the image feature database 169 is, for example, assisting the user in one or more of, positioning and/or moving the transducer, setting the imaging parameters, positioning and/or moving the needle.

### Position Estimator

In an exemplary embodiment of the invention, a position estimator module 163 estimates the position and/or distance between the tool and one or more anatomical features. The distance is estimated, measured and/or calculated, for example, along the long axis of the tool (e.g., needle), such as from the end of the tool.

In an exemplary embodiment of the invention, module 163 estimates, measures and/or calculates the distance between the tip of the needle and the closest boundary point of the target tissues (e.g., amniotic fluid, chorionic villus, placenta, uterus, ovary) and/or tissues to avoid contacting with the needle (e.g., fetus, blood vessels, intestine, umbilical cord, bladder, lungs). Optionally, the distance is determined to be zero when the needle pierces through the anatomical feature and is located inside the anatomical feature. Alternatively or additionally, if the needle pierces through the anatomical feature to the other side, the distance is measured in negative values from the closest boundary point of the other side of the anatomical feature to the tip of the needle. Alternatively or additionally, if needle is not lined up with the anatomical feature (e.g., no intersection possible if needle moved forward), the distance is determined to be undefined.

In an exemplary embodiment of the invention, distances are estimated, measured and/or calculated by processing and/or analyzing image 161 and/or one or more successive images 161 (e.g., according to changes between them). Alternatively, transducer position data and/or tool position data (e.g., as will be described below with reference to FIG. 1B) are used to calculated distances without requiring image 161, for example, such as when using an imaging phantom (e.g., with pre-mapped internal anatomical features) and/or a mannequin (e.g., using the image database).

In an exemplary embodiment of the invention, module 163 calculates the direction and/or speed of the tip of the needle, by estimating the path of the needle, for example, according to one or more successive images 161 and/or by using the needle position data. The path of the needle refers to, for example, the future location that the needle will end up in, if the user continues to move the needle along the current trajectory. The path of the needle is estimated and/or extrapolated, for example, by extending the axis of the needle in the direction of motion.

A potential advantage of estimating the direction and/or speed of the needle is predicting future positions of the needle, and/or providing related scores and/or feedback. For example, if the needle is not currently seen on image 161, it may not necessary be an error if the needle is not moving (e.g., user scanning around needle). In another example, if the needle is not currently seen on image 161 but is moving (e.g., towards target), a prediction can be made of when the needle will need to be seen on image 161. In another example, the changes required to keep the moving needle in image 161 (e.g., manipulation of transducer) can be estimated and/or calculated.

In an exemplary embodiment of the invention, the path of the needle is marked on image 161, for example, as one or more of, an arrow, a line, a broken line.

In an exemplary embodiment of the invention, one or more anatomical features that potentially intersect the path of the needle are marked on image 161, for example, by highlighting the feature at the point of intersection.

In an exemplary embodiment of the invention, module 163 triggers an event generator module 139 to generate an unexpected event according to distance and/or absolute position of the needle and/or one or more anatomical features. For example, if the needle is located far from a simulated fetus, the unexpected event can be the fetus moving closer. Details of module 139 will be provided below in the section “Unexpected Events”.

In some embodiments of the invention, positions are estimated using other imaging modalities, such as CT, MRI, x-ray. For example, a needle can be inserted under US guidance, with periodic imaging using CT, MRI (e.g. open MRI) and/or x-ray imaging. The images created with CT and/or MRI are relatively more detailed and/or of a higher resolution than US images, allowing relatively more precise 3D measurements of positions.

### Position Database

In an exemplary embodiment of the invention, the distance and/or position estimated by position estimator module 163 is used to determine performance and/or a score according to a position database 165. Optionally, the performance and/or score is provided to the user as feedback, for example, as a comment displayed on feedback unit 135. FIG. 2B is an example of position database 165 with reference to target tissue, in accordance with an exemplary embodiment of the invention. FIG. 2C is an example of distance database 165 with reference to tissues to avoid, in accordance with an exemplary embodiment of the invention.

Examples of one or more possible entries associated with the tip of the needle relative to the target feature include:

If the needle is a distance away from the target feature, providing an encouraging message, and telling the user to advance the needle. A passing score is associated with positioning the needle such that it will reach the target feature.

If the needle has reached the target (e.g., inside the target), telling the user to perform the procedure. An honors passing score is associated with performing the procedure.

If the needle has been pushed too far, thereby exiting from the other side of the target, telling the user an error has occurred. A failing score is associated with piercing through the target, as excessive damage has been done.

Examples of one or more possible entries associated with the tip of the needle relative to the feature to avoid include:

If the needle is not in the path to intersect the feature to avoid, providing encouraging messages. An honors passing score is associated with reducing the risk of damage.

If the needle is a distance away from the feature to avoid, providing increasing levels of warning as the user gets closer. A pass score is associated with keeping the needle from contacting the feature to avoid.

If the needle has pierced into and/or through the feature to avoid, providing an error message. A failing score is associated with piercing the feature to avoid.

### Feedback

In an exemplary embodiment of the invention, ultrasound training system 101 comprises feedback unit 135, such as a large monitor for viewing by the user and/or nearby observers. Alternatively or additionally, a person can login remotely to unit 135 to obtain feedback. Alternatively or additionally, unit 135 is located remotely, providing for remove viewing of feedback.

In an exemplary embodiment of the invention, feedback unit 135 comprises audio capabilities, such as music, beeps and/or speech.

In an exemplary embodiment of the invention, image 161 is displayed on unit 135 in real time as the procedure (e.g., real or simulated) is being performed.

In an exemplary embodiment of the invention, feedback about performance, for example, comments from databases 159 and/or 165 are displayed and/or read as speech using unit 135.

### Unexpected Events

In an exemplary embodiment of the invention, ultrasound training system 101 comprises unexpected event generator module 139 to simulate and/or create an unexpected event, such as a potentially dangerous clinical situation that can occur suddenly and/or unexpectedly. One or more examples of unexpected events include; the movement of a fetus and/or umbilical cord into the path of the needle.

In an exemplary embodiment of the invention, the unexpected event can be programmed to occur randomly and/or as part of a training script. For example, the fetus can move randomly during a simulated procedure, resulting in a probability of entering the path of the needle. Alternatively or additionally, the fetus can be programmed to move into the path of the needle, for example, to provide a reproducible scenario during an exam situation.

A potential advantage of generating the unexpected event, is to train and/or evaluate users in reacting to similar real clinical events.

### Training Script

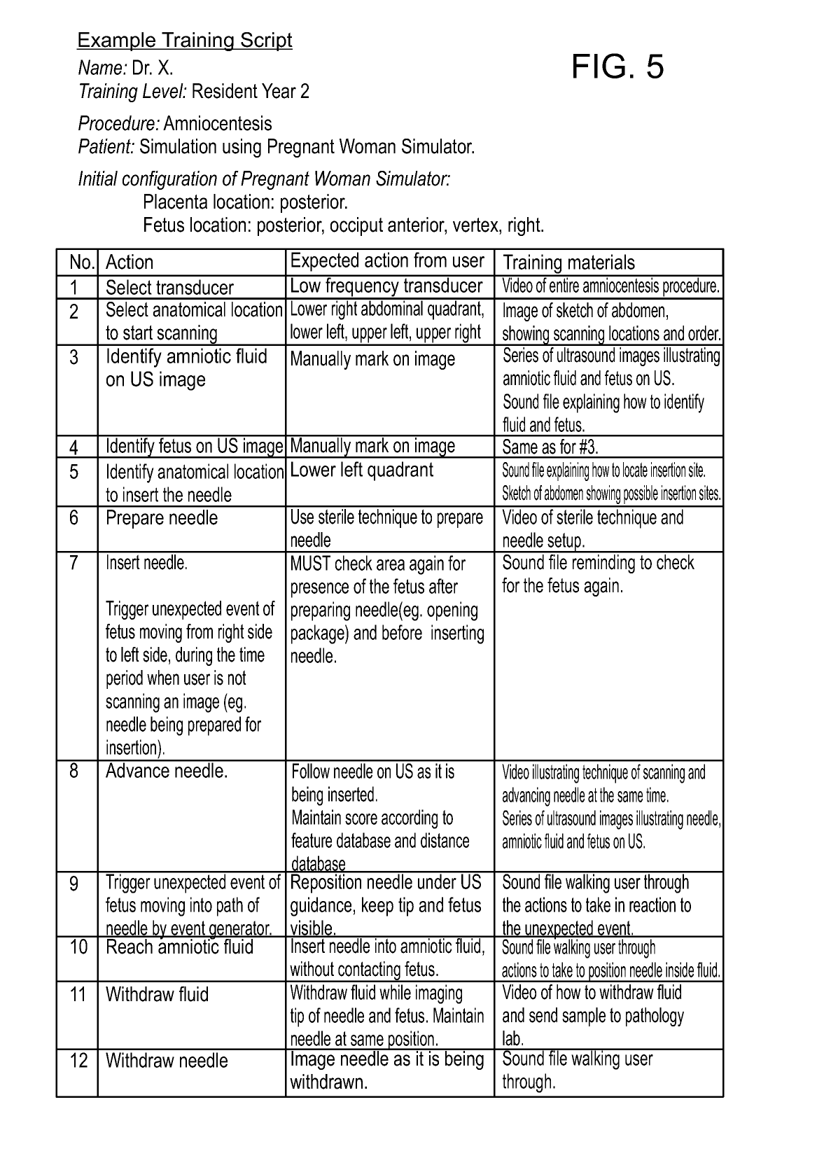

In an exemplary embodiment of the invention, a training script 147 (e.g., a database) is prepared for use with system 101. A potential advantage of training script 147 is to prepare structured training for the users in one or more tasks of the performance of a procedure. FIG. 5 is an example of training script 147, in accordance with an exemplary embodiment of the invention.

In an exemplary embodiment of the invention, script 147 is stored in a memory of system 101.

In an exemplary embodiment of the invention, training script 147 comprises one or more actions expected from the user to perform the procedure, for example, a gold standard protocol developed by a department and/or recommended by professional guidelines. Optionally, the user is evaluated to determine if the steps were followed (e.g., in the right order, out of order where allowed) and/or performed correctly.

In an exemplary embodiment of the invention, training script 147 is linear, for example, the user follows one or more actions in sequence. Alternatively or additionally, script 147 branches, for example, the user can choose to follow one or more actions. Alternatively or additionally, script 147 loops, for example, the user can repeat one or more actions.

In an exemplary embodiment of the invention, training script 147 comprises teaching materials (e.g., multimedia) of how to perform the actions, for example, linked to the steps that the user needs to follow. Teaching of the expected actions can occur before, during and/or after each action, each task and/or after the procedure. Examples of one or more tasks that can be taught include, proper placement of transducer on the object, proper setting of one or more US image parameters, insertion of the needle in the correct location, advancing the needle using US image 161 to the target feature (eg, amniotic fluid), avoiding one or more features (e.g., fetus, bladder, umbilical cord, lungs, intestine, blood vessels), reacting to an unexpected event.

In an exemplary embodiment of the invention, training script 147 is linked to entries in databases 169 and/or 165, to provide additional feedback during procedure performance, for example, training materials, more detailed comments, more encouraging comments.

In an exemplary embodiment of the invention, training script 147 determines the initial position of one or more internal structures of a pregnant woman simulator, for example, the position of the placenta, umbilical cord and/or fetus (as will be discussed below with reference to the section “Pregnant Woman Simulator”).

In an exemplary embodiment of the invention, training script 147 triggers event generator 139 to create one or more unexpected events, for example one or more of, after a user performs a step, after a set amount of time, after the user is taught how to handle a similar situation, randomly. For example, with reference to FIG. 5, an unexpected event of the simulated fetus moving from the initial right sided position has been programmed as step #7. The unexpected event of the fetus moving to the left side has been programmed to occur once the user stops scanning to prepare the needle, and/or after the video review of the sterile technique. In another example, an unexpected event of the simulated fetus moving from posterior to anterior has been programmed as step #9. The unexpected even has been programmed to occur when the distance between the needle and the fetus is >15 cm, to reduce the distance to <5 cm.

In an exemplary embodiment of the invention, training script 147 is easily programmed and/or configured, for example by hospital administration using user interface 143.

### Computer

In an exemplary embodiment of the invention, one or more modules and/or databases 167, 169, 163, 165, 139 and/or 147 are stored on a memory as part of a computer 133. Alternatively or additionally, one or more modules and/or databases are located remotely, such as on a remote server and/or database, accessed for example, by a communication link 145. Alternatively or additionally, one or more modules and/or databases are realized as circuitry, for example, coupled to computer 133. Alternatively or additionally, one or more modules and/or databases are stored on US machine 151 (e.g., software modules stored on memory, circuit boards inserted into expansion slots).

In an exemplary embodiment of the invention, computer 133 is a laptop and/or desktop PC. Alternatively or additionally, computer 133 is a custom designed and/or programmed processor.

In some embodiments of the invention, computer 133 is coupled to one or more communication links 145, for example, by wire and/or wireless, to one or more of, a cellular network, a location area network, an internet connection. Link 145 can be used, for example, for one or more of, upgrading modules and/or databases, downloading data, communicating with other ultrasound training systems, distributed processing, remote processing, connecting to a remote server.

In some embodiments of the invention, at least some of the processing functions can be performed by other processors, for example, by one or more of, a remote processor (e.g., through an internet connection), a local server, a box connected to system 101.

### Exemplary Modes of Operation

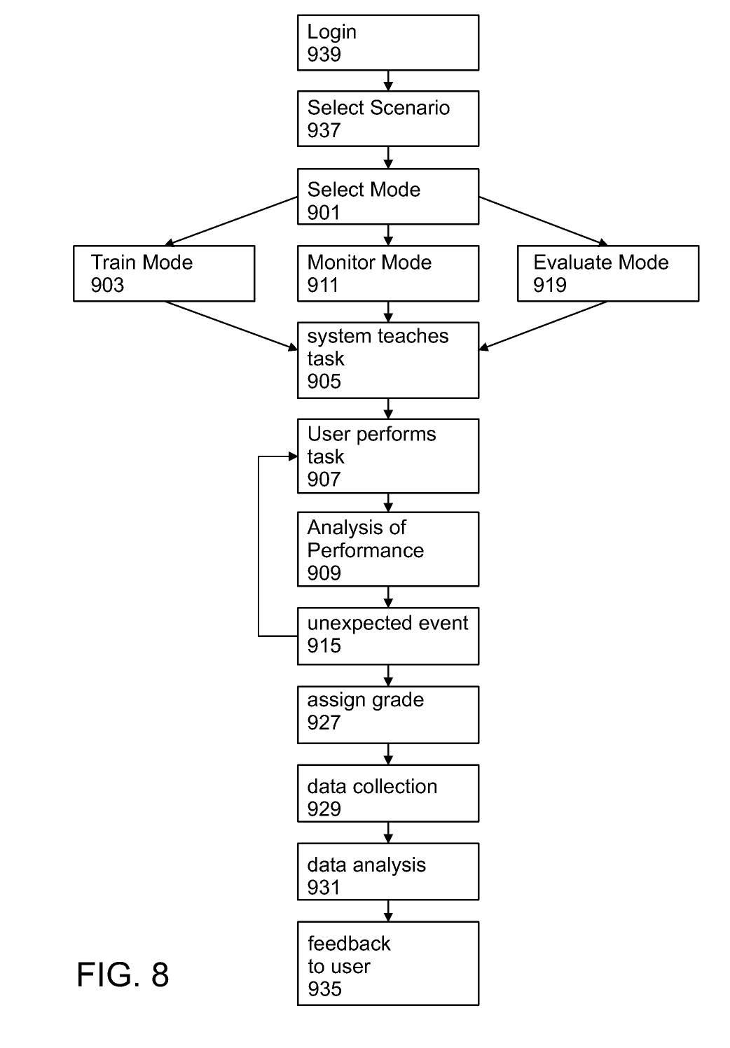

FIG. 8 is a flowchart of modes of operation, one or more of which may be provided, in accordance with some embodiments of the invention. Ultrasound training system can operate in train mode, monitor mode and/or evaluate mode.

Optionally, at 939, the user logs into system 101, for example, through interface 143, such as when the user wants to conduct a training session. Alternatively or additionally, a remote observer logs in, for example, through a remote interface using link 145, such as when conducting exams.

In some embodiments, the user (e.g., physician) logs in using a personal code. A potential advantage of a personal code is preventing others from accessing personal data (e.g., past performances) and/or user profile information.

In some embodiments, the user's (e.g., physician) identify is kept secret, for example, secret to peers, secret to administration, secret to insurance companies, secret to other third parties. A potential advantage of keeping an identify secret is to allow physicians to train and/or practice freely, such as making critical errors and/or mistakes, for example, without fear of one or more of, losing a license (e.g., due to poor performance), being reprimanded (e.g., due to lack of practice), increased insurance payments (e.g., due to need for additional practice).

Optionally, at 937, one or more tasks of a simulated procedure are selected, for example through interface 143, and/or by training script 147, in accordance with an exemplary embodiment of the invention.

In an exemplary embodiment of the invention, tasks are selected to be performed in the same order as when performing a real procedure. Alternatively, tasks are performed in a random order.

At 901, the mode of operation is selected, in accordance with an exemplary embodiment of the invention.

In an exemplary embodiment of the invention, the mode may is selected, for example, by one or more of, the user, an observer, administration, a supervisor. Optionally, the mode is selected locally, for example through interface 143. Alternatively or additionally, the mode is selected remotely, such as through link 145.

Optionally, at 903 training mode has been selected, in accordance with an exemplary embodiment of the invention.

In an exemplary embodiment of the invention, training mode is selected, for example, by a user that wants to learn how to perform the procedure.

In an exemplary embodiment of the invention, training script 147 is used by training mode, for example, as described in the section “Training Script”.

Alternatively, at 911, monitor mode has been selected, in accordance with an exemplary embodiment of the invention.

In an exemplary embodiment of the invention, monitor mode is selected, for example, by an attending physician that has not performed the procedure for a time period and wants to practice before performing the procedure again on a living patient.

In an exemplary embodiment of the invention, monitor mode is selected by a user that is performing a real procedure on a living patient.

In an exemplary embodiment of the invention, monitor mode assists the user in performing the procedure, for example, by providing feedback and/or warnings on avoiding errors, such as from databases 169 and/or 165. Optionally, advice is provided to improve performance, for example, to change the transducer orientation to improve the image.

Alternatively, at 919 evaluate mode has been selected, for example, to assesses the performance of the user in order to assign a grade, in accordance with an exemplary embodiment of the invention.

In an exemplary embodiment of the invention, evaluate mode is selected, for example, in order to test students as part of an examination such as an OSCE (objective structured clinical examination).

In an exemplary embodiment of the invention, evaluate mode is selected, for example, by hospital administration in order to determine the performance level of physicians performing real procedures on living patients as part of a quality assurance program.

Optionally, at 905, ultrasound training system teaches the user how to perform the selected tasks, for example, in association with train mode as in 903, in accordance with an exemplary embodiment of the invention.

In an exemplary embodiment of the invention, teaching materials are selected manually such as by the user. Alternatively or additionally, materials are selected automatically, such as according to training script 147.

In an exemplary embodiment of the invention, teaching material are multimedia, for example integrating text, audio, images and/or video.

In an exemplary embodiment of the invention, teaching occurs before the user starts the task, for example, the user can view how an instructor performs the tasks (e.g., by video). Alternatively or additionally, teaching occurs in real time as the procedure is performed, for example the user is verbally walked through the steps (e.g., by audio and/or video). Alternatively or additionally, teaching occurs after the user has completed the task (e.g., video review).

At 907, the user performs the selected task, in accordance with an exemplary embodiment of the invention.

In an exemplary embodiment of the invention, real and/or simulated ultrasound images 161 are formed according to the manipulation of the transducer on the object and/or patient.

Optionally, the ultrasound images are saved, for example on the memory of computer 133. A potential advantage of saving images 161 is for later review and/or analysis.

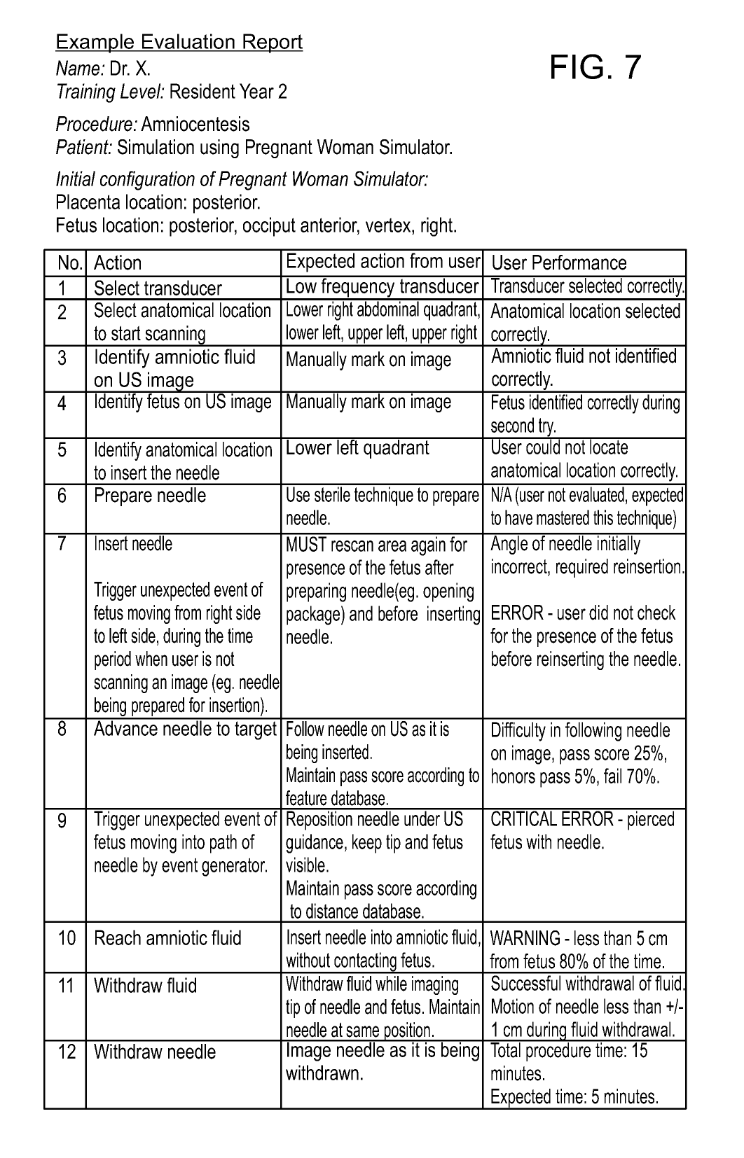

At 909, analysis of the performance of the user is performed, for example, in association with databases 169 and/or 165, in accordance with an exemplary embodiment of the invention. FIG. 7 is an example of a training evaluation report, in accordance with an exemplary embodiment of the invention.

In some embodiments of the invention, the user's control in using the ultrasound system is tracked and/or analyzed. Optionally, sensors are placed on buttons pressed by the user, such as on a keyboard. Alternatively or additionally, input from the buttons and/or from the ultrasound system is obtained. Alternatively or additionally, signals from the buttons to the ultrasound system are intercepted. Alternatively or additionally, a video camera is used to view the user pressing the buttons.

In some embodiments, a video camera records the user performing the task and/or procedure, for example a video may be taken of one or more of, the entire scenario (e.g., user and/or object), the hands of the user, the produced ultrasound image.

In some embodiments of the invention, the user's control in using the ultrasound system is tracked and/or analyzed according to image movements. Optionally, changes between successive movements are analyzed, for example, smooth fluid movements, such as relatively small changes between images (e.g., maintaining the needle tip in most successive images, needle tip slowly changing position between successive images towards the target) suggests proficient use. Alternatively, random, irregular and/or jerky movements between images (e.g., the needle tip appearing randomly in some images and not in others, rapid forward and/or reverse motion of the needle tip) suggest that improvement is required.

In some embodiments, analysis of the user's control is analyzed manually, for example, by presenting the data to an expert for evaluation. The expert may look at data such as videos of the user performing the task and/or the US images created by the user and perform a manual analysis, for example, based on intuition and/or past experience to determine the user's level of proficiency.

In an exemplary embodiment of the invention, performance is evaluated on one or more individual tasks and/or the entire procedure. Optionally, the deviation of the user from the correct way to perform the task as taught to the user in 905 is determined. Alternatively or additionally, analysis is performed to determine if the user has performed and/or will perform an error. Alternatively or additionally, analysis is performed to determine if the user performed the task successfully, such as obtaining amniotic fluid safely. Alternatively or additionally, analysis is performed to determine if the user performed the task sub-optimally, for example one or more of, taking too much time, poking the object too many times with the needle, not selecting the proper transducer.

In some embodiments of the invention, performance analysis occurs manually, for example, by an observer viewing the user and/or the video of the user. Alternatively, analysis occurs automatically, for example, by software. Alternatively, analysis occurs semi-automatically, for example, software identifying and/or flagging data (e.g., video of the user, ultrasound image) for the observer to analyze.

In some embodiments of the invention, data for analysis of the performance of the user is collected automatically by software. For example, after a user logs in with a unique ID, a software module saves the session of the user. Non-limiting examples of data associated with the session include ultrasound images, video images of the user performing the procedure and/or data about the user's control of the ultrasound image settings, probe and/or tool (e.g. collected using sensors).

In some embodiments of the invention, data about the performance of the user is analyzed semi-automatically. For example, the user is given a score as described with reference to FIGS. 2A-C. In another example, software analyzes images and/or data associated with the user's control of the system for possible errors. The possible errors are flagged for manual review.

In some embodiments of the invention, the analysis of the performance of the user is done manually. For example, an expert analyzes the data flagged by software, and/or some of the data associated with the session (e.g. video image, US images, score reports). The expert can detect errors based on his or her experience in performing the procedure, by looking at individual pieces of data and/or looking at the ‘big picture’ through several pieces of data. The expert can provide comments, suggestions and/or a written and/or oral report to the user.

In some embodiments, the performance level of the user in relation to an objective expected level of performance is determined, for example in order to obtain a license. Alternatively or additionally, the performance level of the user in relation to the performance of other users such as peers at the same training level is determined. Alternatively or additionally, the performance level of the user in relation to one or more of the user's prior performances is analyzed, to determine where and/or how user improved.

Optionally, at 915, an unexpected event is generated by event generator module 139, in accordance with an exemplary embodiment of the invention, for example, a fetus moving into the path of the needle, causing the distance between the needle and the fetus to be very close.

In an exemplary embodiment of the invention, the user is expected to react to the unexpected event by performing one or more tasks as in 907, for example, withdrawing and/or repositioning the needle.

In an exemplary embodiment of the invention, the performance of the user in reacting to the unexpected event is analyzed as in 909, for example, by determining and/or analyzing the new distance between the needle and the fetus.

Optionally, at 927 a grade is assigned, in accordance with an exemplary embodiment of the invention, for example, if evaluation mode is selected. Examples of one or more grades include, pass/fail, a score between 0 and 100%, a letter grade.

In an exemplary embodiment of the invention, the grade is assigned according to the analysis of the performance of the user, for example, according to the feature database 169 and/or position database 165.

In some embodiments of the invention, the grade is assigned by a manual review of an expert observer. Based on the observer's experience in working and viewing a relatively large number of users performing the same procedure, the observer gives an opinion as to the level the user is performing at, for example, the level of a medical student, a junior resident, a senior resident and/or a staff physician.

In some embodiments of the invention, the grading system is programmable and/or adjustable. For example, the performance to obtain a certain grade can be set by an administrator, such as one or more of, to pass a course, to pass the year, to receive a certificate to perform the procedure, to receive a license.

Optionally, at 929 data is collected and/or recorded (e.g., on memory), in accordance with an exemplary embodiment of the invention. Examples of one or more types of data include, time to complete task and/or procedure, time spent training, monitoring and/or being evaluated, number of tasks and/or procedures completed, number of times needle had to be re-inserted, total distance covered by needle tip, number of critical errors, number of minor errors, number of successful tasks and/or procedures completed, evaluation scores for task and/or procedures.

Optionally, at 931 data is analyzed, in accordance with an exemplary embodiment of the invention. Examples of one or more statistical analysis methods include, average, distribution, maximum and/or minimum.

In some embodiments, data analysis shows trends, for example, an improvement in the evaluation score for a user performing a procedure over time.

At 935, feedback is provided through feedback unit 135, in accordance with an exemplary embodiment of the invention. In some embodiments, the type of feedback is associated with the mode, as selected in 901.

In some embodiments of the invention, all types of feedback are provided in train mode, for example during and/or after the user performs the task and/or while the user is performing the task. Alternatively or additionally, in monitor mode, only the most relevant feedback is provided, such as warnings of critical errors (e.g., fetus in path of needle) while the user is performing the task, but in a form so as not to startle the patient, for example a non-distinguishable beep. Alternatively or additionally, in evaluate mode, feedback is not be provided at all, such as to test the user's performance without any external aids.

In an exemplary embodiment of the invention, feedback is one or more of the following:

feedback on one or more items of a “measurement” group of data items, such as, by way of a non-limiting example, area, diameter, and distance;

feedback on one or more items of an “image setting” group of data items, such as, by way of a non-limiting example, contrast and brightness;

feedback on one or more items of an “orientation” group of data items, such as, by way of a non-limiting example, ultrasound probe orientation and/or mannequin orientation;

feedback on one or more items of a “position” or “location” group of data items, such as, by way of a non-limiting example, ultrasound probe position and/or mannequin position;

a grade and/or quality assessment for each stored ultrasound image;

what data was supposed to be stored with each ultrasound image;

what ultrasound machine settings, or setting ranges, were supposed to be stored with each ultrasound image;

a comparison of any one or more of target values, as optionally kept in a task database, with achieved values;

a comparison of task quality for a specific trainee/practitioner over time; and

a grade provided as feedback for performing an ultrasound task.

Optionally, modes are pre-set, configured and/or customized to comprise one or more of 905, 907, 909, 915 and/or 927, such as by a senior physician using a website login, in accordance with an exemplary embodiment of the invention. For example, grades as in 927 might not be required for train mode. For example, teaching as in 905 may not be required in evaluation mode.

Exemplary Data which May be Associated Per Task

In an exemplary embodiment of the invention, at least some ultrasound tasks (e.g., as described with reference to FIG. 8) which is performed can optionally have one or more of the following data items associated with it:

a unique ID;

ultrasound settings for a beginning of the task, to be set automatically and/or by an instructor;

one or more expected parameters and/or settings for the US image (one or more settings below are optionally set, such as for evaluation purposes, others are left intentionally blank, such as if deemed not relevant for evaluation purposes);
for each US image:
   an angle setting;
   a zoom setting;
   a depth setting;
   a focus location setting;
   an ultrasound program setting (e.g. some US machines have the option of selecting preset values as an initial starting point, for example, preset for scanning abdominal soft tissues)
   an OTI setting;
   a Harmonic Frequency setting;
   a power setting;
   an R setting;
   a gain setting;
   an optional TGC (time gain compensation) setting;
   a position of a fetus (e.g. as will be described below in the section “PREGNANT WOMAN SIMULATOR”), optionally consisting of presentation (e.g., breech or vertex) and/or orientation (e.g., occiput anterior, occiput posterior); and
which ultrasound transducer was used.

An example form is brought below, displayed as Table 1, which, in some embodiments, may be a paper form, and in other embodiments may be implemented via computer, includes example data from the above list of data. Fields in the example form are optionally partially filled by a trainer and/or monitoring person prior to setting an ultrasound task, and optionally partially filled by a trainee and/or monitored person during fulfillment of the ultrasound

TABLE 1

| | |
|---|---|
| Procedure | Procedure name: |
| ID: | |
| User: | |
| Trainer: | |

Initial settings
Ultrasound machine details

| | | | | | | | | | | Har | | Man | Transducer |
|---|---|---|---|---|---|---|---|---|---|---|---|---|---|
| No. | Program | Focus | depth | zoom | angle | TGC | gain | R | power | Freq | OTI | Pos. | type |
| 1 | | | | | | | | | | | | | |

Task/Actions
Ultrasound machine details

| Task | | | | | | | | | | Har | | Man | Transducer |
|---|---|---|---|---|---|---|---|---|---|---|---|---|---|
| no. | Program | Focus | depth | zoom | angle | TGC | gain | R | power | Freq | OTI | Pos. | type |
| 1 | | | | | | | | | | | | | |
| 2 | | | | | | | | | | | | | |
| 3 | | | | | | | | | | | | | |
| 4 | | | | | | | | | | | | | |

### Alternative Embodiments

FIG. 1B illustrates some alternative embodiments of an ultrasound training system, as used in accordance with an exemplary embodiment of the invention. In some embodiments, elements are provided to simulate ultrasound images 161 for use with an exemplary embodiment of the invention. Alternatively or additionally, elements are provided to increase the simulation experience using real images 161, for example, increasing the accuracy of estimating the relative distances and/or positions, improving visibility of the tool on image 161.

In some embodiments of the invention, the ultrasound training system comprises a mock transducer 125 (e.g., not having ultrasound scanning functionality). Optionally, transducer 125 simulates a functional transducer, for example, by being interchangeable (e.g., exchanging one transducer for another causes images 161 to be simulated according to the new transducer). Examples of one or more transducer 125 shapes and/or functions include, flat (e.g., high frequency such as for superficial scanning), rounded (e.g., low frequency, such as for deep scanning), thin rod (e.g., transvagina and/or transrectal scanning). Alternatively, transducer 125 is a functional ultrasound transducer, such as part of ultrasound machine 151.

In some embodiments of the invention, one or more transducer position sensors 127 are coupled to transducer 125 (e.g., located thereon). Optionally or alternatively, sensors 127 are located on an object 123 (e.g., mannequin and/or imaging phantom such as of a human body), for example distributed across the surface of object 123 (e.g., touch sensors).

In some embodiments, sensors 127 generate transducer position data 105. Optionally, transducer position data 105 is defined by six degrees of freedom (e.g., x,y,z coordinates, angles for yaw, pitch, roll), associated with the position of transducer 125 relative to object 123.

In some embodiments, one or more sensors 127 transmit wireless position data 105 to one or more wireless receivers 141 (e.g., located in near proximity). Wireless receivers 141 can determine position, for example by triangulation of signal strength, and/or by wavelength offset. Alternatively, sensor 127 transmits data by wire, for example, to computer 133.

In some embodiments of the invention, ultrasound training system 101 comprises one or more tools, such as needle 129, to perform and/or simulate an invasive ultrasound guided procedure, for example on object 123, and/or on a patient. Optionally, needle 129 is a mock needle, such as a solid and/or hollow tube without a sharp tip. Alternatively, needle 129 is a real needle, such as used to perform procedures.

In some embodiments of the invention, one or more needle position sensors 131 are coupled to needle 129. Needle position sensor 131 functions similarly to transducer position sensor 127 in terms of position measurements and/or communication abilities. Optionally, sensor 131 is located at the base and/or handle of needle 129.

In some embodiments of the invention, needle 129 comprises one or more elements to increase visibility on ultrasound image 161, when being scanned by functional transducer 125. Optionally, a bead inside needle 129 causes needle 129 to vibrate at a set frequency. Alternatively or additionally, a coil is placed inside needle 129. Alternatively or additionally, an insert comprising a coil is placed inside needle 129.

In some embodiments of the invention, needle 129 and/or sensor 131 generate tool (e.g., needle) position data 107 for use by an image formation module 109 (e.g., as will be described below in the section “Method of Simulating the Ultrasound Image”). In some embodiments of the invention, transducer 125 and/or sensor 127 generate transducer position data 105 for use by module 109. Optionally, data 107 and/or 105 is transmitted to module 109 wirelessly by one or more receivers 141.

In some embodiments of the invention, data 107 (e.g., using needle 129 and/or sensor 131) and/or data 105 (e.g., using transducer 125 and/or sensor 127) are used by feature identification module 167 and/or position estimator 163 module, for example, to increase accuracy of estimating and/or calculation of distances and/or feature identification.

In some embodiments of the invention, an invasive procedure (e.g., using needle 129 and/or transducer 125) is simulated on object 123. Optionally, object 123 is a mannequin (e.g., puppet, empty cylinder), for example, a prop of a body and/or body part that is empty (e.g., hollow) inside, and/or made out of materials (e.g., plastic) that do not form a suitable image when scanned by a functional ultrasound transducer. A potential advantage of using a mannequin is that the ultrasound images 161 are simulated, for example using module 109 as described below, providing for a variety of simulation scenarios without having to have multiple objects 123. Alternatively or additionally, object 123 is an imaging phantom, for example, a body and/or body part, made out of materials such as simulated tissues that result in ultrasound images similar to ones that would be obtained when imaging a living patient. A potential advantage of using an imaging phantom is that ultrasound images 161 can be formed using a functional ultrasound machine and processed as described with reference to FIG. 1A, providing for a ‘real life’ simulation experience using the same US machine as used to perform real procedures. Alternatively or additionally, one or more parts and/or simulated tissues of object 123 are translucent and/or transparent to allow visualization inside object 123.

In some embodiments, object 123 is a pregnant woman simulator 323 as will be described below with reference to the section “Pregnant Woman Simulator”. Alternatively, object 123 is a living patient or animal. Alternatively, object 123 is a cadaver of a human or animal.

In some embodiments of the invention, a user interface 143 is used to input data to and/or control system 101. User interface 143 can comprise for example, one or more of, a keyboard, a monitor, a touchscreen, voice recognition.

In some embodiments, user interface 143 is locally coupled to computer 133. Alternatively or additionally, examples of one or more remote interfaces 143 (e.g., remotely coupled to computer 133) include, a website, a PDA, a smartphone, a laptop.

In some embodiments of the invention, image parameters 137 for simulated and/or real image 161 are set and/or adjusted. Examples of one or more parameters 137 include, scanning frequency, image gain, 2D, 3D and/or 4D scanning mode, Doppler mode.

In some embodiments, parameters 137 are adjusted on US machine 151. Alternatively or additionally, parameters 137 are adjusted through user interface 143.

In some embodiments, parameters 137 can be set and/or adjusted, for example, by one or more of, a user, an instructor, a remote observer, automatically to assist user, (e.g., by training script), preset according to training script.

Use of parameters 137 to simulate image 161 will be described below with reference to the section “Method of Simulating Ultrasound Images”. A real ultrasound image 161 having been created with parameters 137 is processed as image 161, for example, as described with reference to FIG. 1A.

### Exemplary Method of Simulating the Ultrasound Image

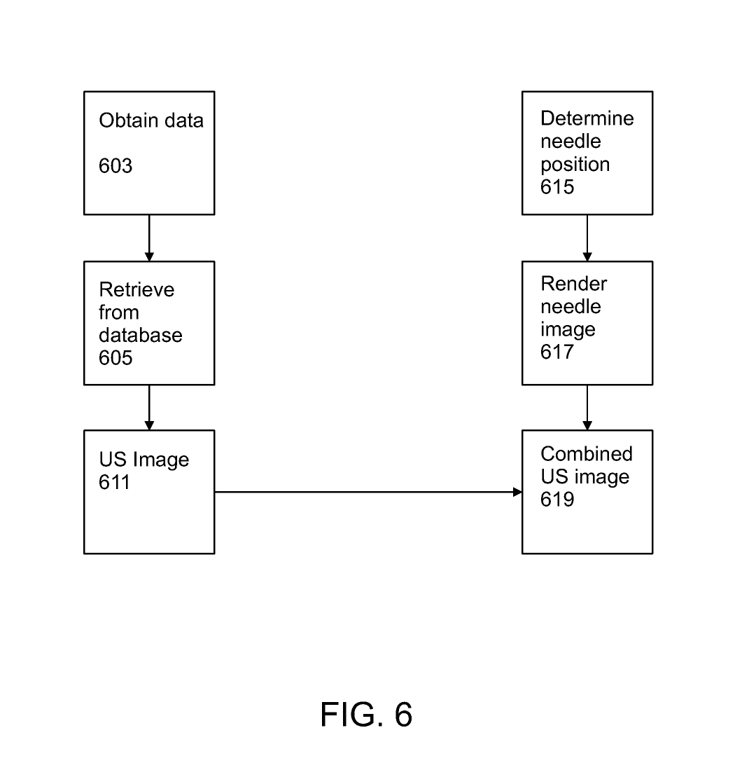

In some embodiments of the invention, ultrasound images 161 are simulated by an image formation module 109, for example, by retrieving the simulated ultrasound image from a database such as an ultrasound image database 171 (e.g., of voxels). Optionally, the image of tissues is simulated. Alternatively or additionally, the image of the needle is simulated. FIG. 6 is a flowchart of the function performed by the image formation 109 module of FIG. 1, in accordance with some embodiments of the invention.

At 603, in accordance with some embodiments of the invention, data used to locate the simulated ultrasound image is provided as input to module 109, for example, one or more of, transducer position data 105, image parameters 137, event generator 139.

At 605, in accordance with some embodiments of the invention, the simulated ultrasound image is retrieved from database 171, for example, according to transducer position data 105, such as described in U.S. Pat. No. 5,609,485, incorporated herein by reference in its entirety.

In some embodiments of the invention, database 171 has stored therein ultrasound images (e.g., voxels) that have been obtained for example, from one or more of, a living person, an imaging phantom, created by software. Optionally, enough images exist to approximately cover the range of images that could be obtained by performing an ultrasound scan of a person as part of the procedure. For example, database 171 comprises images of a fetus inside a pregnant woman that were obtained for example, including one or more of, every several centimeters, every several degrees, using different transducer types (e.g., shapes), using different parameters 623 (e.g., frequencies), from one or more scanning locations. Alternatively or additionally, incorrectly scanned images are stored, for example, to allow the user to simulate incorrect scanning.

In some embodiments, the retrieved simulated image undergoes further processing to provide simulated ultrasound functions, for example, image quality modification according to image parameters 137 and/or movement (e.g., animation) according to event generator 139, for example, as described in U.S. Pat. No. 5,609,485.

At 611, in accordance with some embodiments of the invention, the simulated ultrasound image is obtained.

In some embodiments of the invention, the image as in 611 undergoes further processing, for example, to include the image of needle 129. Alternatively or additionally, a real ultrasound image (e.g., produced by a functional ultrasound machine) undergoes further processing, for example, to simulate the image of needle 129. A potential advantage of simulating needle 129 with a real US image 161 is for example, to create the image of needle 129 in the case of using a needle that does not appear well on an ultrasound image.

Optionally, in accordance with some embodiments, at 615 needle position data 107 is analyzed in order to determine the location of needle 129 relative to image 161 and/or image as in 611, for example, the intersection of needle 129 with the scanning plane, in accordance with some embodiments of the invention.

Optionally, in accordance with some embodiments, at 617, the image of the needle as in 615 is simulated, in accordance with some embodiments of the invention.

In some embodiments, the image of needle 129 as it appears on an ultrasound image is obtained from an image database (e.g., similar to database 171). Alternatively or additionally, the image of needle 129 is rendered by software.

Optionally, in accordance with some embodiments, at 619, an image 161 is obtained by combining the image of the needle as in 617 with the US image as in 611, for example by overlaying the two images, in accordance with some embodiments of the invention. Alternatively or additionally, the image of the needle as in 617 is combined with a real ultrasound image as produced by a functional US machine.

In some embodiments, the combined US image 161 is displayed to the user on feedback unit 135.

In some embodiments of the invention, one or more parts of an image (e.g., image 161) are simulated. Optionally, the simulated part is combined with a real ultrasound image. Alternatively or additionally, the simulated part is combined with a simulated ultrasound image (e.g., from a different ultrasound image database). For example, the image of a fetus can be simulated. In another example, an unexpected event can simulated (e.g., fetus moving into path of needle). A potential advantage is to use an imaging phantom that does not have a fetus for simulating an obstetrical procedure.

### Pregnant Woman Simulator

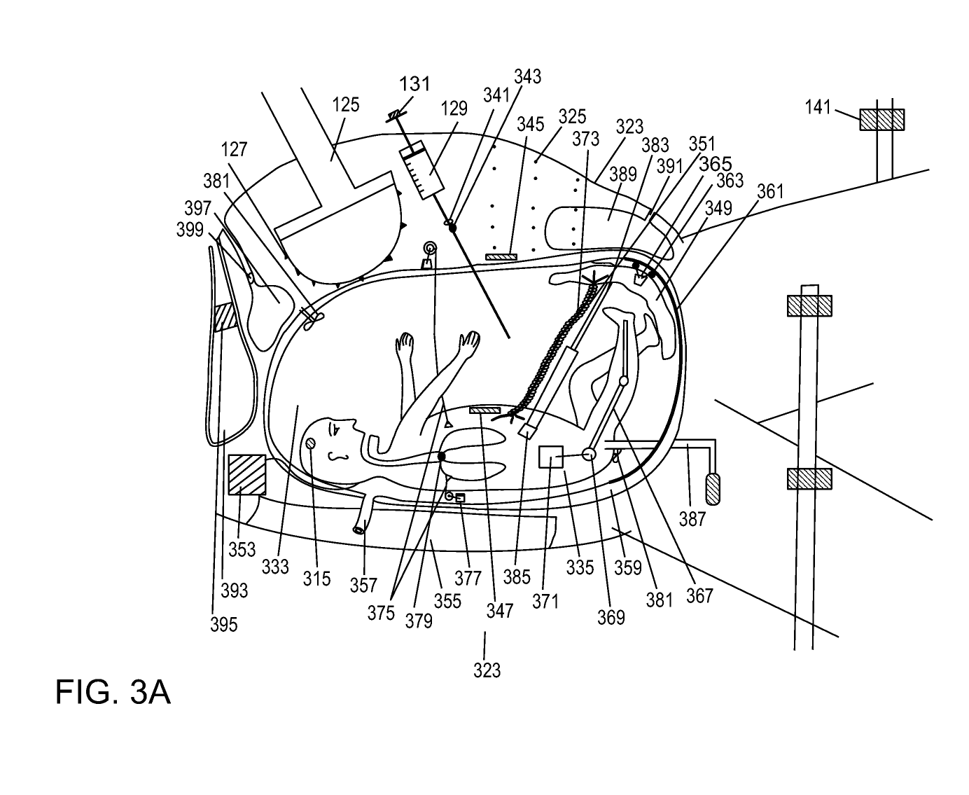

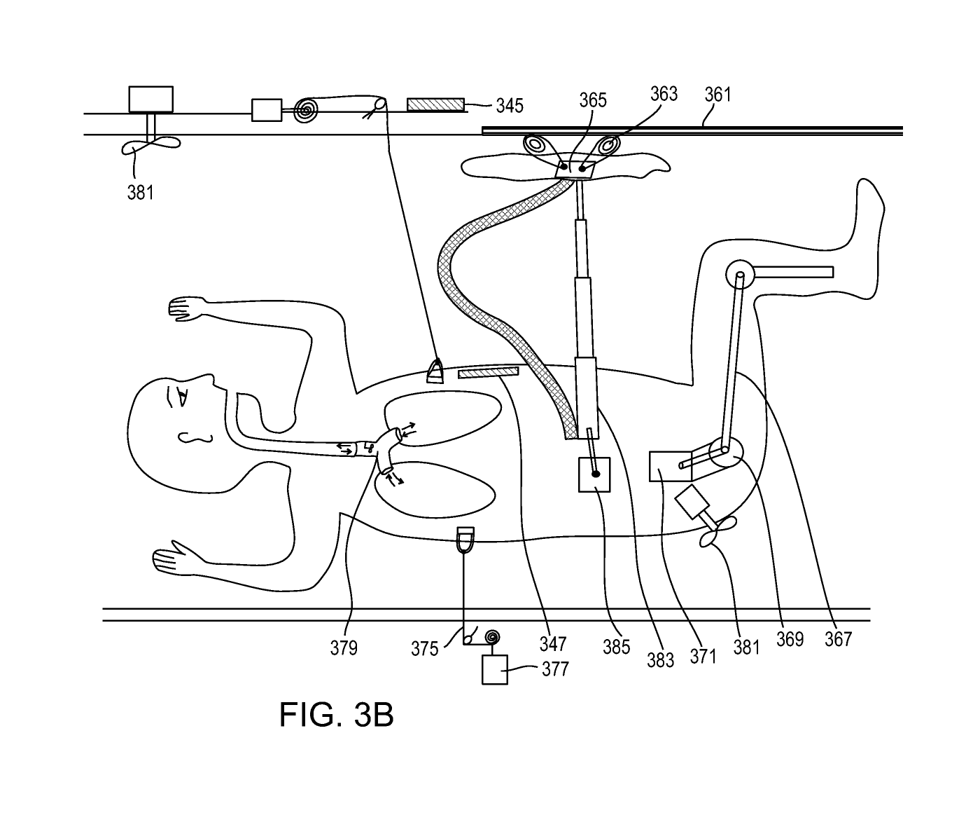

FIG. 3A is an illustration of a pregnant women simulator 323, in accordance with an exemplary embodiment of the invention. FIG. 3B is a close up illustration of exemplary systems enabling movement of some tissues of pregnant woman simulator 323 of FIG. 3A, for example, one or more of, electromechanical, pneumatic, hydraulic, magnetic, manual. Pregnant woman simulator 323 is designed to simulate invasive obstetrical procedures, for example, amniocentesis and/or chorionic villus sampling, by comprising one or more simulated internal organs and/or a fetus 335.

In an exemplary embodiment of the invention, simulator 323 is scanned by and/or is coupled to system 101, for example, as described herein with reference to FIGS. 1A and/or 1B. Optionally, one or more needle position sensors 131 are coupled to needle 129. Alternatively or additionally, one or more transducer position sensors 127 are coupled to transducer 125. Alternatively or additionally, one or more position sensors 325 (e.g., touch sensors to locate transducer 125) are coupled to simulator 323, for example, located on scanning surface of simulator 323.

In some embodiments, at least one fetal position sensor 315 (e.g., a multiple position sensor) is coupled to fetus 335. For example, sensor 315 indicates the angle of rotation of fetus 335 along the cranial-caudal axis. In some embodiments, sensor 315 generates fetal position data defined, for example, by six degrees of freedom. Optionally, fetal position data is used to adjust transducer position data 105 and/or needle position data 107, for example, if transducer position data 105 is 15 degrees to a reference point and fetal position data is also 15 degrees to the reference point, the adjusted transducer position data is zero degrees relative to the reference point.

In some embodiments, adjusted transducer position data and/or adjusted needle position data is used in place of position data 105 and/or 107, for example, by module 109 to create a simulated ultrasound image. Alternatively or additionally, fetal position data is used in addition to position data 105 and/or 107.

In some embodiments, one or more of sensors 127, 325, 351 and/or 131 communicate with one or more wireless receivers 141.

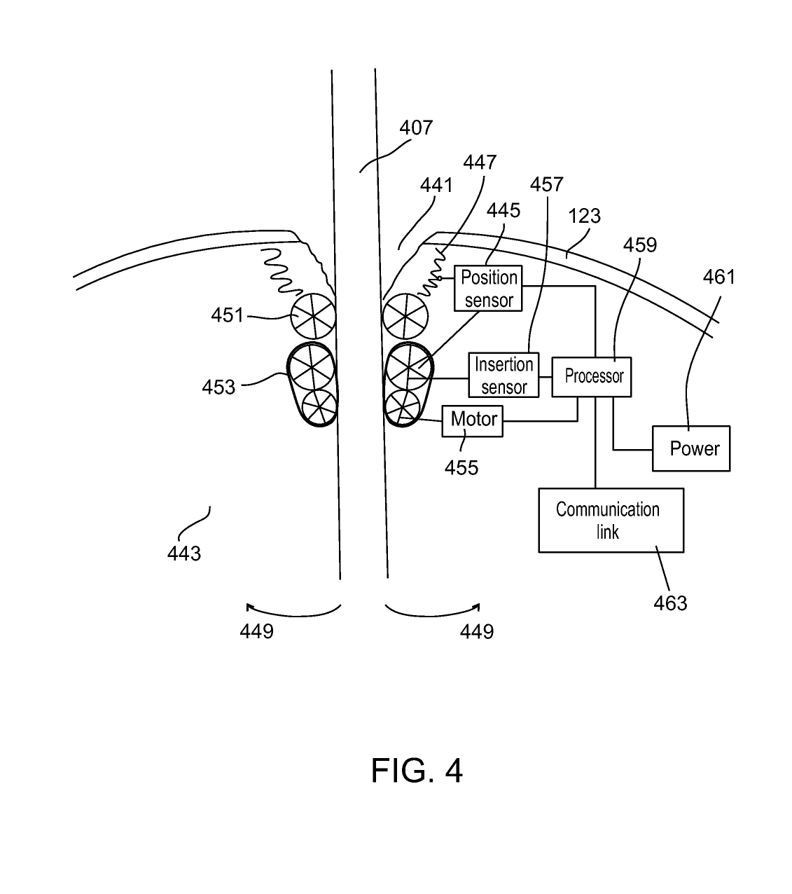

In an exemplary embodiment of the invention, simulator 323 comprises one or more holes 341 for the insertion of a tool, for example, needle 129. Optionally, holes 341 have an associated tool resistance device 343, for example, as will be discussed in more detail with reference to FIG. 4.

In an exemplary embodiment of the invention, simulator 323 comprises simulated maternal lungs 393, for example, to simulate maternal breathing. Optionally, breathing is simulated by a pump 395 pumping air into lungs 393 (e.g., balloon) to expand and/or contact lungs 393. Optionally, breathing lungs 393 cause movement of fetus 335, for example, by pushing against a uterus 359 and/or amniotic fluid 333.

In an exemplary embodiment of the invention, simulator 323 comprises simulated material intestines 397. Optionally, a pump 399 pumping air into intestines 397 (e.g., balloon) to expand and/or contract intestines 397 simulates peristalsis, gas and/or fecal matter.

In an exemplary embodiment of the invention, simulator 323 comprises a maternal bladder 389. Optionally, bladder 389 can be filled and/or drained with a variable amount of simulated urine, for example, through a bladder access port 391.

In an exemplary embodiment of the invention, simulator 323 comprises at least one fetus 335. Fetus 335 may range in size from 1 cm to 60 cm, corresponding to 1 to 42 weeks of pregnancy, for example, fetus 335 ranges in size from 3 cm to 20 cm, corresponding to 10 to 20 weeks of pregnancy. Optionally, fetus 335 includes an inflatable chamber for changing the size.

In an exemplary embodiment of the invention, simulator 323 is inflatable, for example the abdomen is inflatable, to simulate various weeks of pregnancy, such as from 0 weeks to 43 weeks.

In an exemplary embodiment of the invention, simulator 323 simulates women of a variety of heights, for example, 130 cm, 150 cm, 170 cm, 190 cm, 210 cm, or other smaller, intermediate or larger heights.

In an exemplary embodiment of the invention, simulator 323 simulates women of a variety of weights, for example, 40 kg, 50 kg, 70 kg, 100 kg, 200 kg, or other smaller, intermediate and/or larger weights. Optionally, simulator 323 covers a combination of heights and/or weights.

In some embodiments of the invention, a kit is available with a variety of fetuses 335 and simulators 323, for example, to represent one or more combinations of, height (or mother), weight (of mother), gestational age (of mother), height (of fetus), gestational age (of fetus). In some embodiments, the kit contains twins and/or triplets of fetuses for simulation.

In some embodiments of the invention, fetus 335 includes markers and/or beacons, for example, to enhance the obtained ultrasound image.

In an exemplary embodiment of the invention, fetal 335 movements are simulated. Examples of one or more fetal 335 movements include, limb flexion, limb extension, limb adduction, limb abduction, limb internal rotation, limb external rotation, limb elevation, limb depression, fetal displacement and/or rotation (e.g., in six degrees of freedom), fetal breathing.

In an exemplary embodiment of the invention, the position of fetus 335 (e.g., the entire body) is set before the start of the simulation (e.g., automatically by system 101 and/or manually by instructor, for example, using lever 387, optionally lever 387 is removable to prevent knowledge of position), such that the position is not known to the user. Examples of one or more positions include: left and/or right, anterior and/or posterior (e.g., relative to mother), breech and/or vertex (head up and/or down), occiput anterior vs posterior (e.g., direction back of baby's head faces relative to mom). Alternatively or additionally, the fetus 335 is able to move during the simulation, for example, according to training script 147 triggering an unexpected event by event generator 139. Examples of one or more movements of fetus 335 in accordance to script 147 and/or an unexpected event include, movement from posterior position to anterior position, thereby coming very close to the needle, such as randomly during a procedure. Another example, is the user planning to insert the needle on the left side of the abdomen (e.g., fetus 335 on the right side). During the preparation of inserting the needle, fetus 335 moves to the left side, such that user inserts needle into fetus 335 if the area has not been rechecked. Alternatively or additionally, fetus 335 is moved by shaking simulator 323.

In an exemplary embodiment of the invention, fetal 335 movements are controlled, for example, by a controller 353 configured to control a motor connected to one or more fetal 335 body parts. For example, limb movements occur by a motor 371, moving one or more rods 367, connected to one or more hinges 369. For example, fetus 335 can change positions by a motor 377, controlling a cable and pulley 375, attached to the body of fetus 335. For example, fetus 335 can change positions by activating an electromagnet 345 to create an attraction magnetic force with a magnet 347 on fetus 335. For example, fetal breathing is simulated by a pump 379, moving simulated amniotic fluid 333 in and out of fetal 335 lungs.

In an exemplary embodiment of the invention, fetus 335 is surrounded by simulated amniotic fluid 333. Optionally, fetus 335 moves and/or floats inside amniotic fluid 333. For example, one or more elements, such as a propeller 381 can be used to create fluid 333 flow, thereby moving fetus 335. Propeller 381 can be positioned on fetus 335 and/or on wall of uterus 359. For example, fetus 335 can be moved by one or more magnets, for example, electromagnets that are controlled by a controller.

In an exemplary embodiment of the invention, the volume of amniotic fluid volume of amniotic fluid 333 can vary, for example, relative to the volume of fetus 335 (e.g., simulated age of fetus 335) to simulate medical conditions such as oligohydramnios and/or polyhydramnios. Alternatively or additionally, amniotic fluid 333 can be inserted and/or removed through an access port 357.

In an exemplary embodiment of the invention, at least some of amniotic fluid 333 is removable, for example, by a needle as part of a simulated amniocentesis procedure.

In an exemplary embodiment of the invention, fetus 335 is located inside uterus 359. Optionally, uterus 359 is made out of a material which closes in on punctures, such as rubber that allows for needle 129 to pass through and/or does not leak after needle 129 is removed. Alternatively or additionally, the size of uterus 359 can be changed to reflect different gestational ages and/or sizes of fetus 335. For example, uterus 359 can be replaced, and/or made out of a material such as rubber, which is able to expand and/or contract with the amount of fluid 333 therein.

In an exemplary embodiment of the invention, fetus 335 comprises umbilical cord 351. Optionally, umbilical cord 351 simulates normal vessels 373, by having two umbilical arteries and/or one umbilical vein. Alternatively or additionally, umbilical cord 351 simulates blood flow through one or more blood vessels 373, for example, by a pump that pumps a liquid through vessels 373, such that the flow appears on a Doppler scan. Alternatively or additionally, the position of umbilical cord 351 is controlled to twist and/or straighten, for example by the user of a telescopic rod 383 and/or motor 385. Motor 385 can change the orientation of umbilical cord 351 by changing the length and/or rotation of telescopic rod 383 attached to ends of umbilical cord 351. For example, a long rod 383 causes a straight umbilical cord 351. For example, a short rod 383 causes a curve in the center of umbilical cord 351. Motor 385 can also rotate rod 383, thereby rotating umbilical cord 351.

In an exemplary embodiment of the invention, one or more tissues of simulator 323 simulate bleeding, for example when pierced by needle 129. Optionally, umbilical cord blood vessel 373 “bleeds” when pierced by needle 129, for example, the bleeding appearing on ultrasound and/or Doppler.

In an exemplary of the invention, simulator 323 comprises placenta 349. Placenta 349 is connected to umbilical cord 351 and/or to uterus 359. Optionally, placenta 349 is positioned to simulate anatomic variations, for example, anterior placenta (e.g., at the front wall of uterus 359), posterior placenta (e.g., back wall of uterus 359) and/or placenta previa (e.g., floor of uterus 359). Position of placenta 349 can be varied, for example, by a motor 365 moving placenta 349 with wheels 363 along a track 361. Optionally, placenta 349 position is determined, for example, by one or more of, randomly, according to training script 147, manually by the user, manually by an observer. A potential advantage of changing the placenta 349 position is to set the procedure difficulty level. For example, accessing the amniotic fluid 333 by needle 129 (e.g., amniocentesis) through the abdominal route is easier with a posterior placenta and/or more challenging with an anterior placenta.

In an exemplary embodiment of the invention, motion and/or position changes of one or more of simulator 323, fetus 335, placenta 349 and/or umbilical cord 351 are controlled by one or more control circuitry, for example, according to one or more of, and/or a combination of one or more of:
Event generator 139 triggered by training script 147, for example, as described in the section “Training Script”.
User preferences, for example, a user using a visual interface 143, (e.g., mouse and computer screen) to move the fetus 335 around in order to study how it appears on ultrasound.
Randomly, for example, if no specific instructions were programmed.
A look-up table (e.g., on memory of computer 133), for example, comprising entries of positions associated with various difficulty levels (e.g., easy for medical students: placenta 349 posterior and/or fetus 335 posterior; intermediate for residents: placenta 349 posterior and/or fetus 335 anterior; difficult for staff physicians: placenta anterior and/or fetus 335 anterior).
An observer selection (e.g., remotely through link 145), for example, a physician supervising an exam situation, that wants to test the user by moving fetus 335 into the path of the needle when the user does not expect it (e.g., user distracted).

In an exemplary embodiment of the invention, one or more components of simulator 323 can be removed for maintenance, repair, upgrades and/or cleaning, for example, through door 355.

### Biopsy and Other Procedures

In some embodiments of the invention, one or more tissues of simulator 323 simulate a biopsy, for example by comprising a material that can be removed by needle 129. Optionally, the tissues used for simulating the biopsy are replaceable.

In some embodiments of the invention, placenta 349 is designed to simulate a biopsy, such as chorionic villus sampling. Optionally, placenta 349 is made out of a material easily penetrable and/or removable by a needle to simulate a core biopsy, such as foam. Alternatively or additionally, placenta 349 is made out of a self-sealing material such as rubber, filled with a fluid and/or gel designed to be removed by a needle to simulate a fine needle aspiration biopsy.

In some embodiments of the invention, other types of biopsies in other organs and/or tissues are simulated, for example, using simulator 323. Some non-limiting examples of tissues (optionally replaceable) that can be biopsied under US guidance include the breast and/or thyroid.

In some embodiments of the invention, other types of US guided procedures can be performed using simulator 323 (e.g., to prevent x-ray radiation to the fetus). Optionally, procedures are experimental, being developed and/or tested using simulator 323. For example, catheter based procedures, such as inserting a vascular closure device into the heart of fetus 335 (e.g. for closing a ventricular septal defect) can be performed, for example, by access through blood vessels 373 of umbilical cord 351. Another example is US guided ablation of tissues, for example, RF (radiofrequency) ablation of a tumor on fetus 335.

The above description of the ultrasound training system to simulate procedures in pregnant women is meant to be non-limiting, as the ultrasound training system can be used for training in other clinical procedures using a variety of other tools. For example, insertion of drains, such as in the gallbladder and/or to treat pleural effusions. For example, to insert central lines, such through the jugular vein.

### Needle Resistance Simulation Device

FIG. 4 is an illustration of a tool resistance simulation device 443, in accordance with some embodiments of the invention. Device 443 is designed to simulate the resistance of using a tool, such as a needle 407 to perform an invasive procedure on object 123. Optionally, device 443 is used in conjunction with system 101, in providing needle position data 107, for example, in addition to and/or instead of needle position sensor 131,

In some embodiments, an insertion sensor 457 detects the insertion of needle 407. Optionally, sensor 457 provides data 107 to system 101, for example, to verify that the user inserted needle 407 into the correct anatomical location, such as required by training script 147 (e.g., fetus on right side, need to insert needle on left side).

In some embodiments of the invention, one or more holes 441 (e.g., on object 123 and/or simulator 323) have an associated device 443, for example needle 407 is inserted into object 123 through hole 441, thereby engaging resistance device 443. Alternatively or additionally, needle 407 comprises device 443, for example, allowing the user to select any hole 441 to use. Alternatively or additionally, device 443 can be inserted into any hole 441 (e.g., independently and/or before needle 407), for example, allowing the user to select any hole 441 to use.

In some embodiments of the invention, needle 407 is inserted into device 443 at an angle, and/or the angle of needle 407 can be changed once it has already been inserted into device 443, for example, as represented by direction arrows 449. Optionally, a flexible member 447, such as a spring, provides for the angular motion.

In some embodiments of the invention, device 443 comprises one or more motion control elements 451, such as a wheel, surrounded by a traction element 453 such as a track. Optionally, motion control element 451 and/or traction element 453 are placed at an angle relative to the axis of the needle 407, to provide for rotational motion. Alternatively or additionally, element 451 and/or element 453 are controlled by a motor 455. Motor 455 allows for varying degrees of resistance during forward and/or reverse motion of needle 407 to simulate the insertion of needle 407, for example, needle hitting bone (ie prevention of forward motion), needle inserted into large fluid filled area (ie easy forward motion), patient coughing (ie random needle motion). Alternatively, resistance is simulated by an element such as a spring.

In some embodiments of the invention, a needle position sensor 445 provides needle position data 107, for example, angles according to flexible member 447 and/or position of the tip in space according to elements 451 453 and/or motor 455 (e.g., by calculating the length of the tip inserted).

In some embodiments of the invention, device 443 is controlled by control circuitry such as a processor 459. Processor 459 may be coupled to position sensor 445, and/or motor 455. Processor 459 can perform one or more functions such as, data collection, data processing, data analysis and/or control output to sensors 445 and/or motor 455. Optionally, processor is coupled to computer 133, for example, to obtain instruction on providing resistance, such as simulating hitting bone according to needle position data 107, for example, to send position data from sensor 445 and/or 457 to system 101.

In some embodiments of the invention, processor 459 communicates using a communication link 463, for example, with computer 133.

In some embodiments of the invention, processor 459 is located beside hole 441, in object 123. Alternatively or additionally, processor 459 is distributed, and/or located on a remote server. Alternatively or additionally, computer 133 performs one or more functions of processor 459.

In some embodiments of the invention, a power source 461 such as a battery and/or electrical outlet provides power to device 443.

### Exemplary Feedback Screens of Integrated System

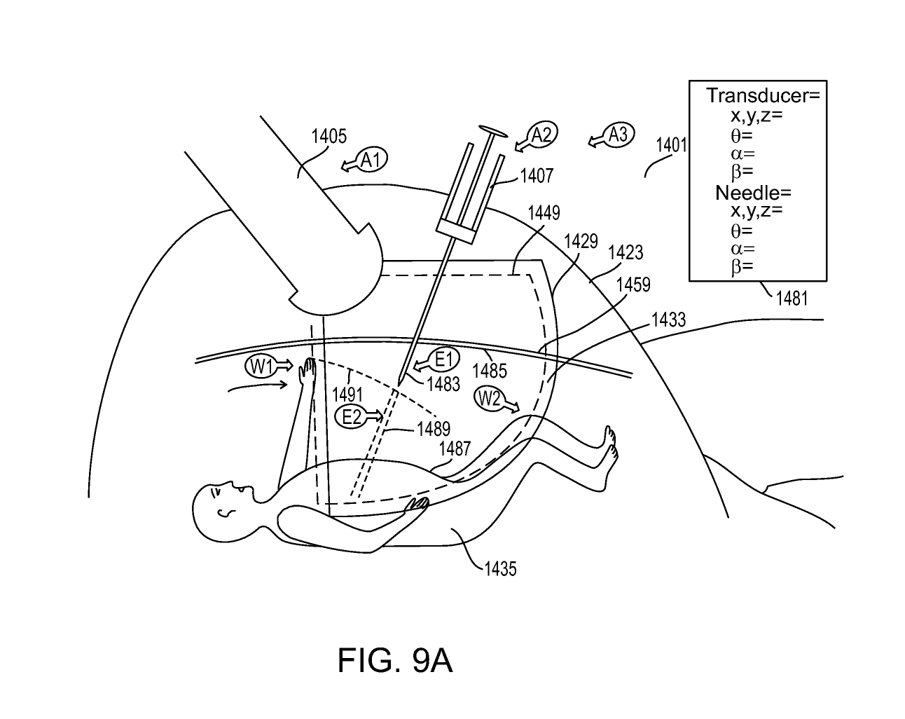

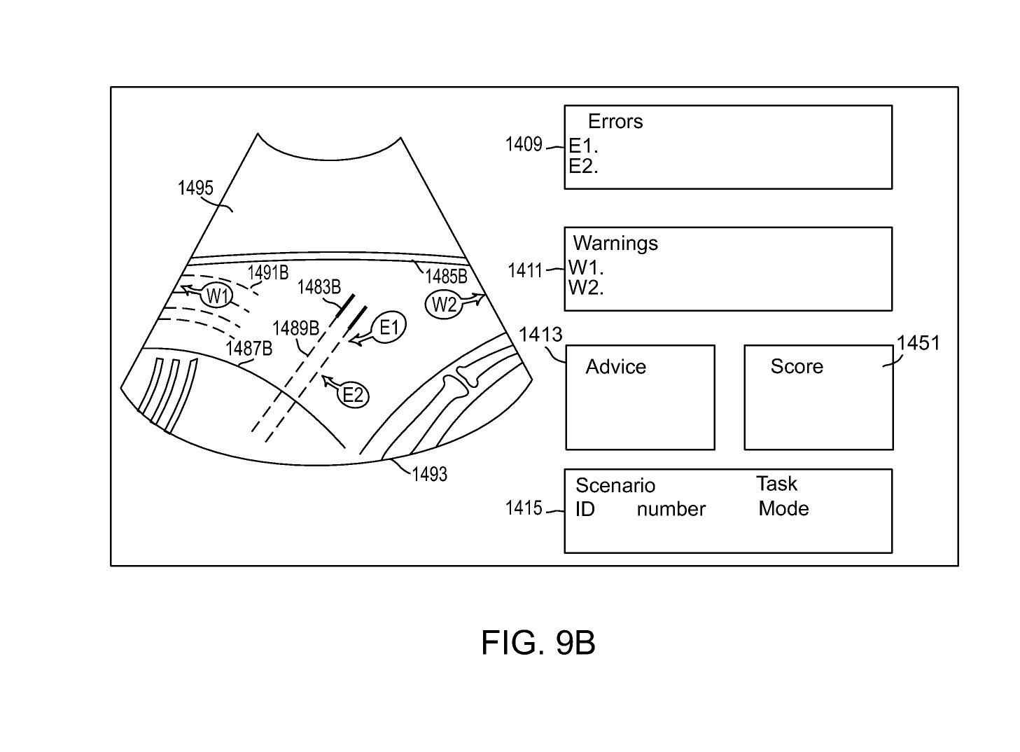

FIGS. 9A and 9B are illustrations of a possible screen capture of feedback unit 135, in accordance with an exemplary embodiment of the invention. Illustrated is the use of system 101 together with the object, such as pregnant woman simulator 323. In an exemplary embodiment of the invention, a 3D rendering 1401 is displayed on feedback unit 135. 3D rendering 1401 is a three dimensional skeleton/outline of an object 1423, for example, a stored sketch of simulator 323.

In an exemplary embodiment of the invention, 3D rendering 1401 displays and/or has marked thereon one or more features, for example, one or more of, landmarks structures (used to help the user visually identify the location of the scanning plane) such as a simulated uterus 1459, target features such as simulated amniotic fluid 1433, features to be avoided such as a simulated fetus 1435. Optionally, other structures such as simulated abdominal muscles are lightly outlined and/or not shown at all.

In an exemplary embodiment of the invention, 3D rendering 1401 is updated for example, in real time. Alternatively, rendering 1401 is updated according to one or more changes, such as the movement of a simulated fetus inside a pregnant woman simulator, for example, using data from a position sensor coupled to the fetus.

In an exemplary embodiment of the invention, a scanning plane 1429 (e.g., corresponding to image 161) is displayed on feedback unit 135, for example, according to transducer position data 105. Optionally, plane 1429 is shown as a slice and/or section through 3D object 1423 and/or any internal features such as fetus 1435. Alternatively or additionally, the intersection points and/or features are highlighted, for example, selectively. For example, illustrated is scanning plane 1429 intersecting needle 1407 at the needle tip, shown as a marked needle tip 1483. For example, scanning plane 1429 intersects fetus 1435 at a part of the abdomen and leg, shown as a marked fetus 1487.

For example scanning plane intersects the wall of the uterus shown as a marked uterus 1485.

In an exemplary embodiment of the invention, a recommended scanning plane 1449 is displayed on feedback unit 135, for example, as a slice and/or section through 3D object 1423 and/or needle 1407. In an exemplary embodiment, recommended plane 1449 represents the scanning plane that will produce an ultrasound image suitable for the procedure, for example, the image would obtain the ‘honors-pass’ score according to feature database 169.

In an exemplary embodiment of the invention, plane 1429 and/or plane 1449 are marked differently, for example, using different colors. Optionally, when planes 1429 and/or 1449 overlap (e.g., user manipulates transducer 105 to re-orient plane 1429 to overlap plane 1449), a third marking is used, for example, a third color.

In an exemplary embodiment of the invention, an ultrasound image 1493 corresponding to image 161 displays the important features and/or structures that intersect scanning plane 1429, for example, as identified by feature identification module 167. For example, one or more of, a needle tip 1483B corresponding to marked needle tip 1483, a fetus 1487B corresponding to marked fetus 1487, and/or a uterus 1485B corresponding to marked uterus 1485. Optionally, structures are shown on ultrasound image 1493 that do not appear in 3D rendering 1401, for example abdominal muscles 1495. Alternatively or additionally, ultrasound image 1493 shows trajectories that correspond to trajectories shown on 3D rendered image 1401, for example a needle trajectory 1489B, a fetal hand trajectory 1491B, such as determined by training script 147.

In some embodiments of the invention, an image of the scanning transducer 1405 is displayed, for example, corresponding to the position relative to object 1423 and/or the patient as determined by transducer position data 105.

In some embodiments of the invention, angles and/or coordinates 1481 describing the orientation of transducer 1405 are shown, such as determined by transducer position data 105. For example, on the 3D rendering 1401 itself, and/or in a side box on the screen.

A potential advantage of displaying the orientation of transducer 1405, the orientation of scanning plane 1429 and/or 3D rendering 1401 is providing a visual aid (e.g., visual feedback) to learning to manipulate transducer 1405 to achieve a desired orientation of scanning plane 1429 through object 1423, for example, to overlap scanning plane 1429 with recommended plane 1449.

In some embodiments of the invention, an image of a needle 1407 is displayed in a similar manner as described for transducer 1405.

In an exemplary embodiment of the invention, needle trajectory 1489 is shown through 3D rendering 1401, such as by a dotted outline of the future needle path. Optionally the image of needle 1405 and/or needle trajectory 1489 is obtained using needle position data 107.

In some embodiments of the invention, other trajectories are displayed, for example, the movements of a simulated fetus 1435 that can suddenly appear in the path of needle 1407, for example, as determined by training script 147.

A potential advantage of showing a trajectory, such as a fetal hand trajectory 1491 is teaching and/or practicing possible movements and/or how to react to them.

In an exemplary embodiment of the invention, feedback (e.g., comments), for example, from databases 169 and/or 165 is provided. Feedback can be categorized, for example, as one or more of an error 1409, a warning 1411 and/or an advice 1413. Errors are for example, a performance that is wrong, dangerous and/or harmful to a patient. Warnings are for example, a performance that may result in an error if not corrected. Advice is for example, instructions to correct warnings and/or errors, and/or how to proceed in the procedure. Optionally, advice comprises teaching instructions on performing tasks and/or the procedure. In some embodiments, corresponding errors and/or warnings tell the user when advice and/or instructions are not being followed properly. In some embodiments, a remote viewer can provide feedback, for example, by remotely providing (e.g., manually by typing, speech) one or more of error 1409, warning 1411 and/or advice 1413.

In an exemplary embodiment of the invention, one or more scores 1451, for example, from databases 169 and/or 165 is provided.

In an exemplary embodiment of the invention, markings, for example arrows, referring to errors, warnings and/or advice are displayed on 3D rendered image 1401 and/or ultrasound image 1493. Alternatively or additionally, messages are displayed directly on images 1401 and/or 1493. Examples of errors 1409 include one or more of, E1 indicates that the tip of the needle is not visible in the ultrasound image, E2 indicates that that the tip of the needle is too close to the abdomen of the fetus. Examples of warnings 1411 include one or more of, W1 indicates needle tip may potentially pierce arm if fetus moves; W2 indicates that the leg of the fetus is moving into the path of the needle. Examples of advice 1413 include one or more of, A1 indicates tilting transducer slightly forward to bring the needle tip into the field of view; A2 indicates retracting and/or reposition the needle; A3 indicates changing image gain settings to improve the image quality.

In an exemplary embodiment of the invention, other types of information 1415 are provided, for example, according to the login of the user (e.g., as in 939) and/or training script 147, such as, one or more of, the procedure and/or task the being performed, ID number of the user and/or mode of operation.

### Exemplary Use of Combined System

The example described below, illustrates only one of many possible ways in which ultrasound training system 101 is used to train, assess skills, and/or monitor users in performing ultrasound guided procedures, for example, using pregnant woman simulator 323 to perform an amniocentesis, in accordance with an exemplary embodiment of the invention.

In some embodiments of the invention, a feature database (e.g., database 169) comprises 4 possible states for the identification of a needle tip (e.g. needle 129) in an ultrasound image (e.g., image 161):
Needle tip identified in tissues outside amniotic fluid (e.g., amniotic fluid 333).
Needle tip identified in amniotic fluid.
Needle tip identified in a fetus (e.g. fetus 335).
Needle tip not identified in the ultrasound image.

In some embodiments of the invention, a position database (e.g., database 165) comprises 5 possible states for the position of the needle tip relative to the fetus as seen on the ultrasound image:
Needle tip identified in tissues outside amniotic fluid.
Needle tip identified in amniotic fluid at a distance of greater than 10 millimeters from the fetus.
Needle tip identified in amniotic fluid at a distance of less than 10 millimeters from the fetus.
Needle tip identified inside the fetus.
Needle tip not cannot identified relative to the fetus in the ultrasound image.

In some embodiments of the invention, a “perfect score” (e.g., 100%) in performing the amniocentesis procedure is obtained if the following objectives are met:
The needle tip is initially identified on the US image as being located in tissues outside the amniotic fluid.
The needle tip is identified in successive US image frames until the needle tip reaches the target destination.
The needle tip is advance continuously; the needle tip does not stop moving for longer than 5 seconds at any point until it reaches the target destination.
The needle tip reaches the target destination of no more than 10 mm away from the fetus.

In some embodiments of the invention, one of ten possible scores is assigned according to evaluation set criteria as show in table 2 below, for example, a score of 0, 60, 65, 70, 75, 80, 85, 90, 95 or 100. Scores are multiplied by a weighted factor. The weighted scores are added together to arrive at the total score for the procedure. Optionally, sub-criteria are used to differentiate between multiple possible scores.

TABLE 2

| Evaluation Criteria | 100 | 95 | 90 | 85 | 80 | 75 | 70 | 65 | 60 | 0 |
|---|---|---|---|---|---|---|---|---|---|---|
| Tip initially identified in tissues outside | X | | | | | | | | | |
| amniotic fluid | | | | | | | | | | |
| Tip initially identified in amniotic fluid | | X | X | X | X | X | X | X | X | |
| Tip initially identified in fetus | | | | | | | | | | X |
| Tip identified in every successive US | X | X | | | | | | | | |
| image frame | | | | | | | | | | |
| Tip identified in every frame except for a | | | X | X | | | | | | |
| single sequence up to 10 frames long | | | | | | | | | | |
| Tip identified in every frame except for a | | | | | X | | | | | |
| single sequence up to 15 frames long | | | | | | | | | | |
| Tip identified in every frame except for a | | | | | | X | | | | |
| single sequence up to 20 frames long | | | | | | | | | | |
| Tip identified in every frame except for | | | | | | | X | | | |
| two sequences, each up to 10 frames long | | | | | | | | | | |
| Tip identified in every frame except for | | | | | | | | X | | |
| two sequences, each up to 15 frames long | | | | | | | | | | |
| Tip identified in every frame except for | | | | | | | | | X | |
| two sequences, each up to 20 frames long | | | | | | | | | | |
| Tip initially identified at a boundary of | | X | X | | | | | | | |
| tissues surrounding the amniotic fluid and | | | | | | | | | | |
| the fluid | | | | | | | | | | |
| Tip initially identified up to 10 mm from | | | | X | X | | | | | |
| the boundary | | | | | | | | | | |
| Tip initially 11-20 mm from the boundary | | | | | | X | | | | |
| Tip initially 21-30 mm from the boundary | | | | | | | X | X | | |
| Tip initially >31 mm from the boundary | | | | | | | | | X | |
| Tip >20 mm from the fetus | X | X | X | X | | | | | | |
| Tip 10-20 mm from the fetus | | | | | X | X | X | | | |
| Tip <10 mm from the fetus | | | | | | | X | X | | |
| Tip inside fetus | | | | | | | | | | X |
| Time from the start of US imaging to | X | X | | | | | | | | |
| appearance of tip on the image: <20 | | | | | | | | | | |
| seconds | | | | | | | | | | |
| Time to appearance of tip on image: 21-30 | | | X | | | | | | | |
| seconds | | | | | | | | | | |
| Time to appearance of tip on image: 31-40 | | | | X | | | | | | |
| seconds | | | | | | | | | | |
| Time to appearance of tip on image: >41 | | | | | X | X | X | X | X | |
| seconds | | | | | | | | | | |

### Potential Advantages

A potential advantage of system 101 is to repeatedly practice one or more clinical scenarios that are potentially dangerous, for example, until the user feels comfortable in handling such a case in clinical practice. For example, a user may want to practice an unexpected event, such as the movement of the fetus into the path of the needle. The user can log in to system 101 using user interface 143. The user can review data about past performance, for example to determine one or more common error (e.g., not continuously keeping the needle tip and the fetus on the ultrasound image), for example to determine the current skill level relative to other users.

The user can select to practice the unexpected event. Alternatively, the user can select to practice the amniocentesis procedure and have an unexpected event generated randomly during the procedure. The user can watch a video of how to handle the unexpected event, and/or be walked through handling the unexpected event.

A potential advantage of a simulator such as simulator 323, is practicing the unexpected event without feeling nervous and/or stressed in harming a living fetus. The user can review the current performance of handling the unexpected event and compare this result to past results. The user can see if an error is repeatedly being made, and/or if progress is being made. The user can be tested on handling the unexpected event, for example, as part of a quality assurance program before being allowed to perform such a procedure on real patients.

Repeatedly practicing handling an unexpected event may result in the user handling a real unexpected even in clinical practice correctly, thereby potentially reducing harm to patients and/or their fetuses.

### General

Although the ultrasound training system has been described for needle based, ultrasound guided, invasive procedures in pregnant women, the ultrasound training system can be used for training in other procedures. For example: biopsies, in organs such as the thyroid and breast. For example: insertion of drains such as in the gallbladder and to treat pleural effusions. For example: to insert stents and/or central lines.

It is expected that during the life of a patent maturing from this application many relevant medical simulators will be developed and the scope of the term ultrasound training system is intended to include all such new technologies a priori.

As used herein the term “about” refers to ±10%.

The terms “comprises”, “comprising”, “includes”, “including”, “having” and their conjugates mean “including but not limited to”.

The term “consisting of means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find calculated support in the following examples.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1-17. (canceled)

18. A pregnant woman simulator comprising:
a simulated uterus;
a simulated amniotic fluid within said uterus; and
one or more of a simulated fetus configured to at least one of move or change a position within said uterus and said amniotic fluid.

19. A simulator according to claim 18, further comprising:
a simulated placenta configured to change a position within said uterus.

20. A simulator according to claim 19, further comprising:
a simulated umbilical cord connecting said fetus to said placenta, said umbilical cord configured to move.

21. A simulator according to claim 18, further comprising:
one or more control circuitry configured to at least one of move or change said position.

22. A simulator according to claim 18, wherein said fetus is inflatable to change the size of said fetus.

23. A simulator according to claim 18, further comprising at least one motor to change or move said fetus.

24. A simulator according to claim 19, further comprising at least one motor to change or move said simulated placenta.

25. A simulator according to claim 20, further comprising at least one motor to change or move said simulated umbilical cord.

26. A simulator according to claim 18, further comprising at least one propeller to change or move said fetus.

27. A simulator according to claim 18, further comprising at least one cable to change or move said fetus.

28. A simulator according to claim 18, further comprising at least one magnet to change or move said fetus.

29. A simulator according to claim 18, wherein said simulated placenta comprises a material to simulate a biopsy.

30. A simulator according to claim 18, wherein said movement of said fetus comprises selecting from the group consisting of: limb flexion, limb extension, limb adduction, limb abduction, limb internal rotation, limb external rotation, limb elevation, limb depression, fetus displacement, fetus rotation, fetal breathing.

31. A simulator according to claim 18, wherein said change said position of said fetus comprises selecting from the group consisting of: left, right, anterior, posterior, breech, vertex, occiput anterior, occiput posterior.

32. A simulator according to claim 18, wherein said position of said simulated placenta comprises selecting from the group consisting of: placenta anterior, placenta posterior, placenta previa.

33. A simulator according to claim 18, wherein said amniotic fluid is removable by said tool.

34. A simulator according to claim 18, further comprising a lever configured to said at least one of move or change said position of said fetus.

35. A simulator according to claim 18, further comprising a maternal bladder configured to hold a variable amount of simulated urine.

36. A simulator according to claim 18, further comprising maternal lungs operable to push at least one of uterus or fetus during simulated breathing.

37. A simulator according to claim 18, further comprising maternal intestines operable to simulate peristalsis.

38-48. (canceled)

49. A device for simulating the resistance of a tool used to perform an invasive procedure comprising:
a traction control element to provide varying levels of resistance to a tool;
a motor configured to set traction control element to varying levels of resistance;
an insertion sensor to detect the insertion of the tool;
a flexible member operable to provide angular insertion of the tool;
a position sensor to detect the position of the tool; and
a processor configured to at least one of transmit position data or receive resistance instruction.
